(19) United States
(12) Patent Application Publication
(10) Pub. No.: US 2025/0175371 A1
(43) Pub. Date: May 29, 2025

(54) CYCLIC PARTITIONING METHODS AND PROCEDURES FOR PHASE NOISE COMPENSATION IN CP-OFDM

(71) Applicant: INTERDIGITAL PATENT HOLDINGS,INC., Wilmington, DE (US)

(72) Inventors: Javier Lorca Hernando, Madrid (ES); Umer Salim, Vallauris (FR); Pascal Adjakple, Great Neck, NY (US); Hussain Elkotby, Conshohocken, PA (US); Ahmet Serdar Tan, London (GB); Onur Sahin, London (GB); Allan Yingming Tsai, Boonton, NJ (US); Arman Shojaeifard, London (GB)

(73) Assignee: INTERDIGITAL PATENT HOLDINGS, INC., Wilmington, DE (US)

(21) Appl. No.: 18/869,044

(22) PCT Filed: May 26, 2023
(86) PCT No.: PCT/US2023/023720

§ 371 Date: Nov. 25, 2024

Related U.S. Application Data
(60) Provisional application No. 63/346,180, filed on May 26, 2022.
(60) Provisional application No. 63/394,452, filed on Aug. 2, 2022.

(51) Int. Cl. H04L 25/03; H04L 27/26

(52) U.S. Cl. CPC H04L 25/03821; H04L 27/2607

(57) ABSTRACT

Disclosed herein are a plurality of embodiments addressing wireless communications, where one or more of the embodiments specifically address phase noise (PN) compensation techniques in which multiple groups of reference symbols are transmitted by computed splitting of the allocated Physical Resource Block(s) (PRBs) in suitable groups of sizes (e.g., equal or lower than the channel's coherence bandwidth), and ensuring the frequency domain circular symmetric transmission from the transmitting entity side adding the cyclic sub-carriers to each group. There may be one or more designs of techniques to choose suitable numbers and sizes of groups to enable suitable level of PN compensation at a receiving entity and provide various methods to ensure circular symmetry within each group. One or more approaches may be able to adapt to the instantaneous channel conditions and PN characteristics of the transceivers on a per-user basis.

### CROSS-REFERENCE TO RELATED APPLICATIONS

This application claims the benefit of U.S. Provisional Application No. 63/346,180 filed May 26, 2022, and U.S. Provisional Application No. 63/394,452 filed Aug. 2, 2022, the contents of which are incorporated herein by reference.

### BACKGROUND

In wireless systems, wireless devices (receiving or transmitting) have to deal with issues that may arise in signals. There is a need to ensure that as wireless technologies advance, these issues can be addressed with one or more novel approaches.

### SUMMARY

Disclosed herein are a plurality of embodiments addressing wireless communications, where one or more of the embodiments specifically address phase noise (PN) compensation techniques in which multiple groups of reference symbols are transmitted by a computed splitting of the allocated Physical Resource Block(s) (PRBs) in suitable groups of sizes (e.g., equal or lower than the channel's coherence bandwidth), and ensuring the frequency domain circular symmetric transmission from the transmitting entity side adding the cyclic sub-carriers to each group. There may be one or more designs to choose suitable numbers and sizes of groups to enable a suitable level of PN compensation at a receiving entity and provide various methods to ensure circular symmetry within each group. One or more approaches may be able to adapt to the instantaneous channel conditions and PN characteristics of the transceivers on a per-user (e.g., device) basis.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment; and

FIG. 2 illustrates an example of PT-RS signal allocation in CP-OFDM 5G NR for DM-RS configuration type 1 and 2;

FIG. 3 illustrates an example of cyclic partitioning of M subcarriers into L subcarrier groups with a frequency domain cyclic prefix/cyclic suffix structure respectively prepended and appended to each of them;

FIG. 4 illustrates an example of FD-CP/CS insertion in a subcarrier group;

FIG. 5 illustrates an example of phase noise response showing a one-sided spectral width for −120 dBc/Hz power spectral density;

FIG. 6 illustrates an example of details of a single FD-CP insertion per subcarrier group;

FIG. 7 illustrates an example of details of a single FD-CS insertion per subcarrier group;

FIG. 8 illustrates an example of details of a combined FD-CP/CS insertion per subcarrier group;

FIG. 9 illustrates an example of transmit processing steps for generation of CP-OFDM signals based on phase noise cyclic partitioning;

FIG. 10 illustrates an example of receive processing steps in the proposed cyclic partitioning method;

FIG. 11 illustrates an example of a procedure for the transmission of CP-OFDM symbols based on phase noise cyclic partitioning;

FIG. 12 illustrates an example procedure for the transmission of CP-OFDM symbols based on phase noise cyclic partitioning;

FIG. 13 illustrates an example procedure for the reception of CP-OFDM symbols based on phase noise cyclic partitioning; and

FIG. 14 illustrates an example method for determining and indicating high phase noise according to one or more techniques described herein.

### DETAILED DESCRIPTION

Disclosed herein are a plurality of embodiments, examples, techniques, and approaches that address wireless communications, where one or more of the approaches specifically address phase noise (PN) compensation techniques in which multiple groups of reference symbols are transmitted by a computed splitting of the allocated Physical Resource Block(s) (PRBs) in suitable groups of sizes (e.g., equal or lower than the channel's coherence bandwidth), and ensuring the frequency domain circular symmetric transmission from the transmitting entity side adding the cyclic sub-carriers to each group. There may be one or more techniques to choose suitable numbers and sizes of groups to enable a suitable level of PN compensation at a receiving entity and to ensure circular symmetry within each group. One or more approaches may be able to adapt to the instantaneous channel conditions and PN characteristics of the transceivers on a per-user basis (e.g., per device).

Additionally, disclosed herein are a plurality of methods for wireless communication, where one or more of the methods may be specifically for phase noise compensation in transmissions based on cyclic partitioning of subcarriers, with the ability to adapt to the instantaneous channel conditions, and/or the phase noise characteristics of the transceivers on a per-user basis (e.g., per device). One or more of the methods may include obtaining phase noise information characterizing the amount of phase noise experienced in the communications link. One or more of the methods may include determining the channel's coherence bandwidth, B_{coh}. One or more of the methods may include selecting default values of a subcarrier group size, M, the length of a frequency-domain cyclic prefix, L_{CP}, and the length of a frequency-domain cyclic suffix, L_{CS}, based on B_{coh} and the phase noise information. One or more methods of the methods may include determining if a high phase noise indication is reported by the receiving entity, and/or if the channel's coherence bandwidth is lower than the user's allocated bandwidth, in order to adapt the subcarrier cyclic partitioning parameters M, L_{CP} and L_{CS} to the instantaneous conditions. One or more of the methods may include updating the values of L_{CP} and L_{CS} based on a high phase noise indication received from the receiving entity. One or more of the methods may include performing a Rate Matching function to adjust the amount of data to be mapped to physical resources available after considering the frequency-domain cyclic prefix and/or cyclic suffix fields. One or more of the methods may include sending signaling information containing, for example, values of M, L_{CP} and L_{CS}. One or more of the methods may include transmitting the CP-OFDM symbol.

Additionally, disclosed herein are a plurality of methods for wireless communication, where one or more of the methods may be specifically for phase noise compensation in reception based on cyclic partitioning of subcarriers, with the able to adapt to the instantaneous channel conditions, and/or the phase noise characteristics of the transceivers on a per-user basis. One or more of the methods may include receiving a CP-OFDM symbol. One or more of the methods may include performing channel estimation, equalization, and/or common phase error compensation in the frequency domain of the received CP-OFDM. One or more of the methods may include obtaining a subcarrier group size, M, and the lengths of the frequency-domain cyclic prefix, L_{CP}, and/or frequency-domain cyclic suffix, L_{CS}, via, for example, signaling indications. One or more of the methods may include averaging the phase noise Inter-Carrier Interference (ICI) components estimated in each subcarrier group based on M, L_{CP} and/or L_{CS} greater than zero, and performing phase noise ICI compensation. One or more of the methods may include demodulating the subcarriers and comparing the residual phase noise ICI power against a threshold. One or more of the methods may include determining the phase noise characteristics, for example, a phase noise spectral width, based on said residual phase noise ICI power above a threshold. One or more of the methods may include sending a High phase noise indication containing information about the amount of phase noise expected or experienced in the communications link, for example, phase noise capabilities information and/or phase noise spectral width.

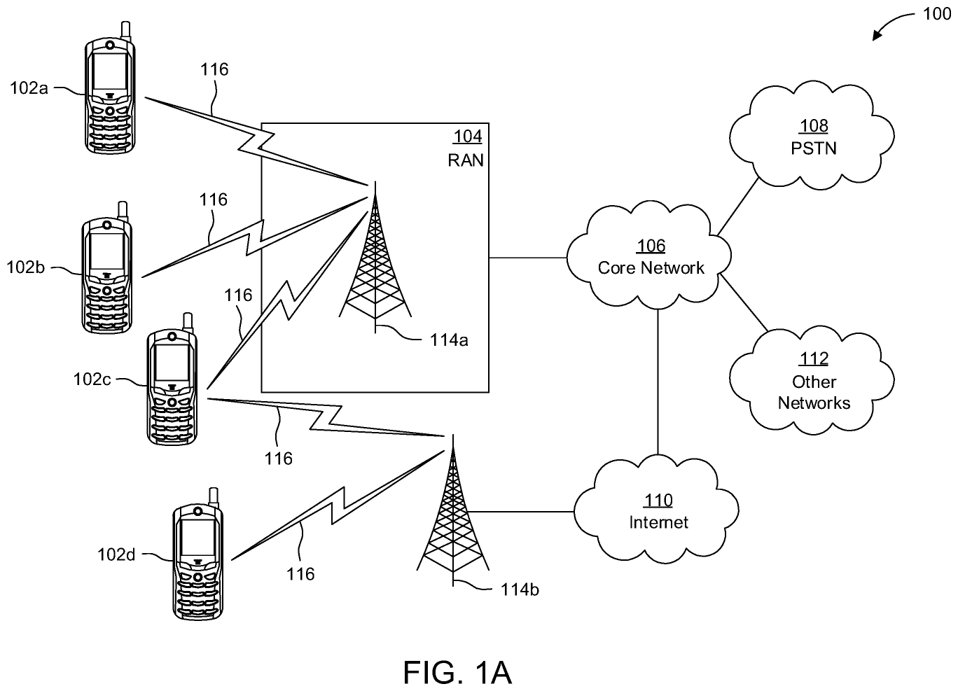

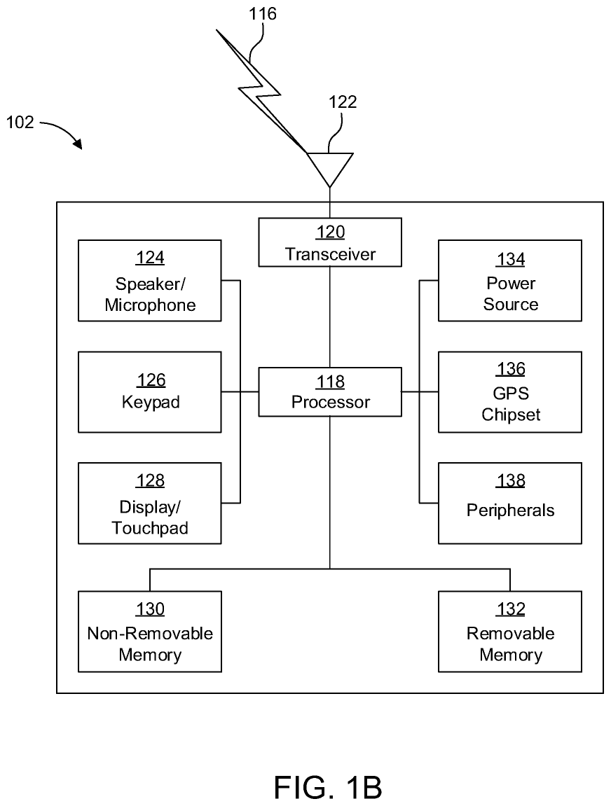

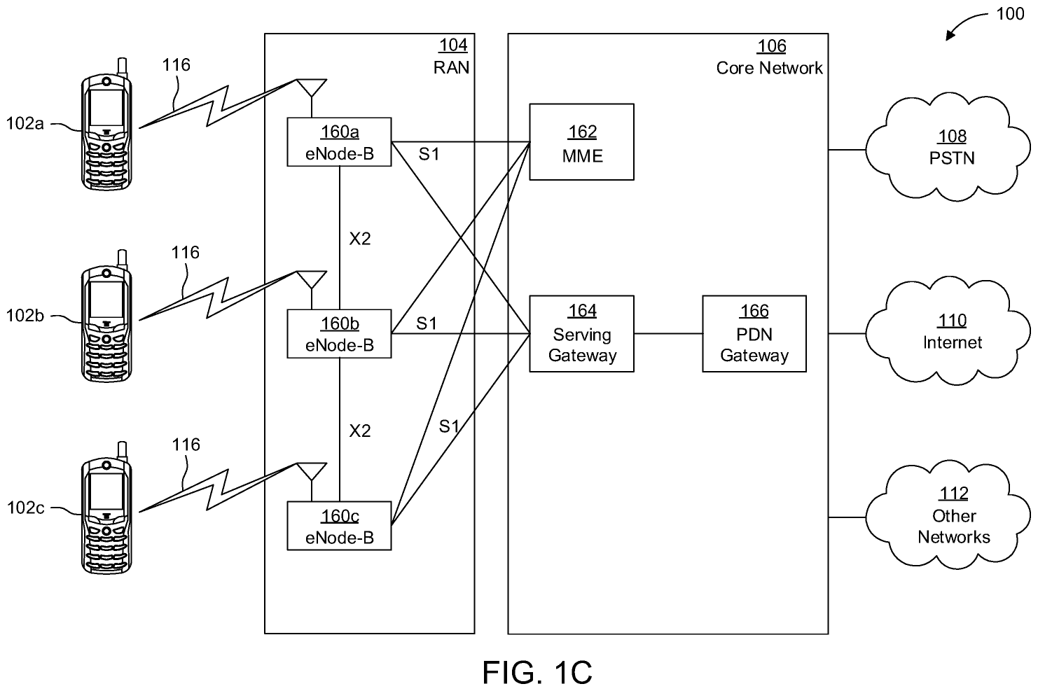

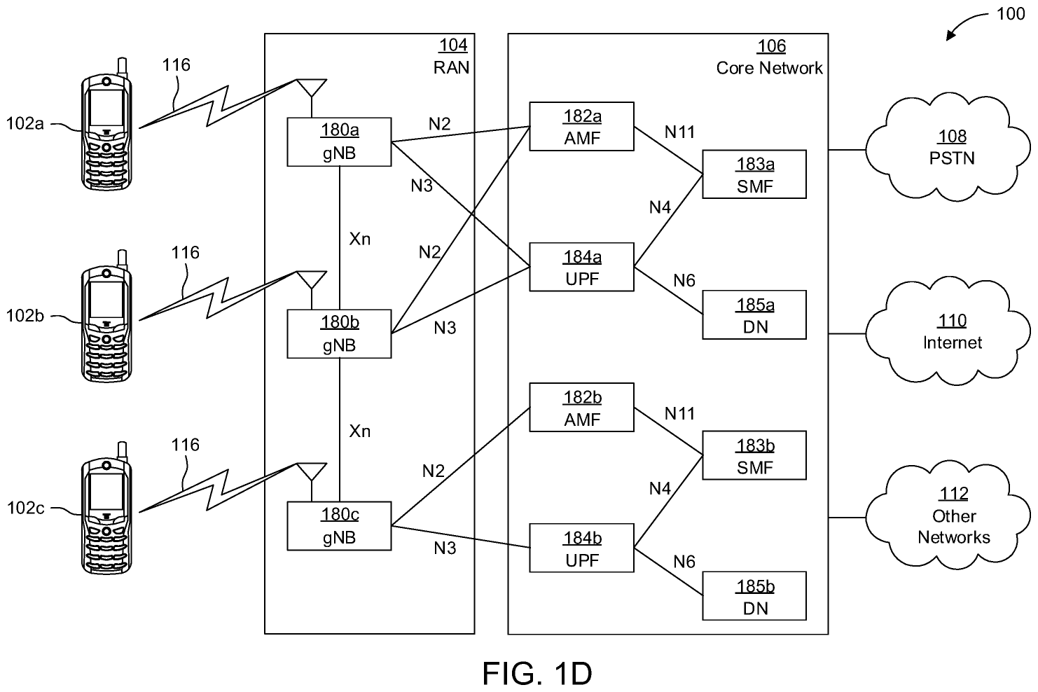

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE. Any reference to a “user” made herein may be interchangeable with a user's device, and/or a WTRU. For example, where a user is allocated bandwidth, this is equivalent to where a WTRU is allocated bandwidth by receiving a configuration grant of a specific bandwidth to use.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a,184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In some cases of transmitting a signal, non-ideal oscillators may generate signals impaired by random phase fluctuations, called phase noise (PN). PN power increases with the square of the carrier frequency, which means that every doubling of frequency causes a 6 dB increase in PN power. Another important factor for phase noise is the way a given frequency is generated and multiplied to reach the required system/carrier frequency. Larger multiplication factor and more multiplications increase the resulting phase noise in the carrier frequency. THz and sub-THz frequencies may therefore be more susceptible to suffer PN issues than the lower frequencies. This may be aggravated further due to immature oscillator technologies currently available to generate such higher frequencies. Multi-carrier waveforms, like Cyclic Prefix—Orthogonal Frequency Division Multiplexing (CP-OFDM) or Discrete Fourier Transform—spread Orthogonal Frequency Division Multiplexing (DFT-s-OFDM), may be especially vulnerable to PN issues because they destroy the orthogonality of the subcarriers introducing inter-carrier interference (ICI).

Phase noise can lead to several impairments on CP-OFDM and DFT-s-OFDM, such as a Common Phase Error (CPE), which represents a constant phase shift applied to all subcarriers of the signal, albeit with small random fluctuations around its value. CPE has a high correlation of its values in the frequency domain, but a low correlation in the time domain due to its unpredictability. Another impairment on CP-OFDM and DFT-s-OFDM may be an ICI term caused by leakage of the subcarriers to the adjacent ones as a result of the loss of orthogonality, thus contaminating the complex amplitudes of the subcarriers with undesired contributions from neighboring ones. ICI may be the result of the phase noise variations within a symbol, for example.

Generally, CPE may be an impairment at mmWave frequencies, whereas for such frequencies ICI contributions resulting from phase noise may be ignored with suitable choice of sub-carrier spacing and reference symbols. For this reason, industry advancements, such as 5G NR or future releases, may wish to address CPE impairments, and/or take specific measures to compensate it in mmWave frequencies, or any frequency where an improvement can be achieved using one or more techniques disclosed herein.

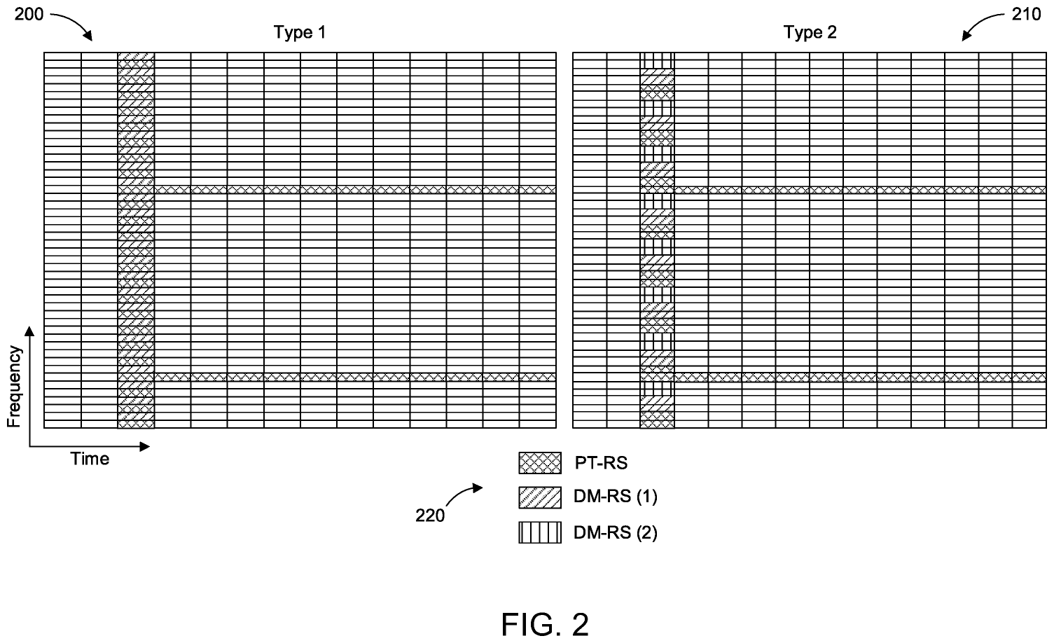

FIG. 2 illustrates an example of PT-RS signal allocation in CP-OFDM 5G NR for DM-RS Configuration Type 1 (200) and Type 2 (210). The horizontal axis depicts time, and the vertical axis depicts frequency, thereby depicting a theoretical range where a wireless signal may be transmitted in time and/or frequency. In one example, time increments may be shown in symbols, and frequency increments may be shown in subcarriers. The impact of common phase error (CPE) may be addressed by introducing a Phase Tracking Reference Signal (PT-RS) aimed at correcting the CPE term at the subcarriers of the received signal. FIG. 2 shows an example of the arrangement of Phase Tracking Reference Signal (PT-RS) signals in Cyclic Prefix—Orthogonal Frequency Division Multiplexing (CP-OFDM) for two Demodulation Reference Signal (DM-RS) configurations, namely Configuration Type 1 (200) and Type 2 (210). CPE compensation may be deemed essential in Frequency Range 2 (FR2) to ensure good performance, particularly at higher order modulations. At 220, there is an example legend: the squares with both left and right leaning lines represents PT-RS, the squares with right leaning is DM-RS (1) and the square with vertical lines is DM-RS (2) (e.g., two DM-RS, each of different ports). In one instance, all blank squares may be either no signals, data signals, or some other non-RS.

However, CPE alone may not be sufficient to avoid signal degradation when carrier frequencies are increased towards the sub-THz regime. To this end, subcarrier spacing may be increased to reduce the impact of ICI, and all related OFDM parameters are changed accordingly leading to different numerologies (e.g., in 5G NR) to cope for frequencies from below 1 GHz up to mmWave frequencies. However, above a certain carrier frequency the subcarrier spacing needs to be so large that the cyclic prefix may no longer absorb the delay spread of the channel, or the reduced symbol duration may impair coverage beyond acceptable limits. This motivates the need to explicitly mitigate phase noise-induced ICI at sub-THz and THz frequencies.

ICI may have a deeper impact on CP-OFDM than on DFT-s-OFDM mainly for one or more reasons: the higher time resolution allowed by the former to track phase noise variations within a symbol, and/or the extra frequency diversity introduced by the spreading operation. In some cases, PN at carrier frequencies from 52.6 to 71 GHz (FR2-2 frequencies) may be addressed by new numerologies and PT-RS enhancements, to better cope with it. However, further improvement may still be needed to address potential gains obtained from the new PT-RS designs (e.g., for CP-OFDM or DFT-s-OFDM). In some cases, block-based PT-RS designs may be impacted by the channel's coherence bandwidth, and that several PT-RS blocks might need to be allocated in a clustered fashion to refine the phase noise estimates by averaging over PT-RS blocks, with a separation between clusters being determined by the channel's delay spread. This may be demonstrated by simulations.

As a result of the advancements of technology, one or more problems in wireless systems associated with phase noise (PN) may exist. PN is a severe issue at very high frequencies whose power grows with the square of the carrier frequency and cannot be solely avoided by frontend designs. PN-induced ICI dominates over CPE at sub-THz frequencies, and may be harder to compensate due to the loss of orthogonality that it produces on the subcarriers. Increased subcarrier spacing can partially alleviate phase noise-induced ICI, but it may face a limit above a certain frequency because of insufficient support of channel's delay spread from the shorter cyclic prefix, and/or loss of coverage from the reduced symbol duration. In addition, it may not be feasible to limit the system to a single very wide sub-carrier spacing for multitude of devices with a wide range of capabilities.

Further, PN degradation may be more severe in CP-OFDM than in DFT-s-OFDM waveforms primarily resulting from the PT-RS design leading to estimation granularity on the basis of one CP-OFDM symbol. ICI compensation solely based on receiving entity strategies, like de-ICI or Wiener filters, have limited gains and may pose significant complexity to practical receiving entities. For instance, such receive strategies were borderline acceptable for FR2-2 systems due to significant CPE compared to ICI contributions. With sub-THz and THz systems, such designs may fail in view of the PN increase with carrier frequencies and higher oscillator inefficiencies. Block-based PT-RS designs may benefit from clustered arrangements in which multiple PT-RS blocks are leveraged to refine the PN ICI estimation through averaging over the blocks. The number of PT-RS blocks and their relative frequency distances may be dependent on the channel's coherence bandwidth, whereas the size of each PT-RS block depends on the width of the phase noise spectral response. Hence, there may be no single solution that can cope with all possible devices and channel characteristics.

Additionally, coexistence of devices with very different capabilities and qualities in a same cell may lead to PT-RS designs based on a worst-case scenario, thus considering the maximum possible phase noise spectral width and the minimum possible channel's coherence bandwidth. Such designs may lead to significant overhead and resource inefficiencies. Phase noise mitigation requirements may be very different depending on the reliability or performance requirement of the application, and PN compensation schemes capable to adapt to different applications or device characteristics are not yet available.

Generally, there is a need to address phase noise, and/or related aspects, of a wireless system in order to address the one or more problems identified above, and/or one or more problems that may exist in any wireless system. In order to better cope with PN-induced ICI impairments in CP-OFDM, there may be one or more approaches for PN compensation in which multiple groups of reference symbols are transmitted by computed splitting of the allocated PRBs in suitable groups of sizes equal or lower than the channel's coherence bandwidth, and/or ensuring the frequency domain circular symmetric transmission from the transmitting entity side adding the cyclic sub-carriers to each group. Such approaches outline the techniques to choose a suitable number and size of groups to enable suitable level of PN compensation at a receiving entity and provides various methods to ensure circular symmetry within each group. The approaches may also include the mapping of complex data symbols and reference signals to subcarriers in the frequency domain groups to help the receiving entity mitigate phase noise in a way that can better adapt to the transceiver characteristics and the channel conditions.

For purposes of illustration, herein it may be assumed that a CP-OFDM symbol is scheduled for transmission of one, or several, frequency-multiplexed signals in a wireless communication system impacted by phase noise. Transmission to/from any given user (e.g., for a given device) will comprise Mₐ subcarriers allocated to it. In the downlink of such a wireless communication system, the transmitted signal may address multiple users each comprising a different number of allocated subcarriers that share the same time resources via frequency-multiplexing, or spatial-multiplexing, of the complex modulated symbols. In the uplink, the transmitted signal corresponding to a given user may be assumed to comprise Mₐ allocated subcarriers. The full system bandwidth will comprise N subcarriers corresponding to the Discrete Fourier Transform (DFT), or Fast Fourier Transform (FFT), size needed to switch between the time and frequency domains.

Phase noise impairments may be seen as a randomly varying constant-envelope multiplicative noise term e^{jθ[n]} that impacts the time-domain samples x[n] in every CP-OFDM symbol. The signal corrupted by phase noise, assuming no other impairment from either the channel or the transceiver, can be written in the form:

$$r [ n ] = x [ n ] \cdot {e}^{j θ [ t ]} + w [ n ] = ( \frac{1}{\sqrt{N}} {\sum }_{k = 0}^{N - 1} {X}_{N} [ k ] {e}^{j \frac{2 π kn}{N}} ) {e}^{j θ [ n ]} + w [ n ] , n = 0 , … , N - 1 ,$$

where θ[n] is the random phase noise term encompassing the phase impairments introduced at the transmitting entity oscillator and receiving entity oscillator, w[n] is an additive white Gaussian noise term, and X_{N}[k] are the complex subcarrier amplitudes of the signal in the frequency domain after an N-point DFT. Multiplication in the time domain can be seen as a circular convolution in the frequency domain, thus we can write:

$${R}_{N} [ k ] = {X}_{N} [ k ] {⊗}_{N} {P}_{N} [ k ] + {W}_{N} [ k ] , k = 0 , … , N - 1 ,$$

where ⊗_{N} denotes an N-point circular convolution and R_{N}[k], P_{N}[k] and W_{N}[k] are the N-point DFT of r[n], x[n] and w[n] respectively:

$${R}_{N} [ k ] = \frac{1}{\sqrt{N}} {\sum }_{n = 0}^{N - 1} r [ n ] {e}^{- j \frac{2 π kn}{N}} , {P}_{N} [ k ] = \frac{1}{\sqrt{N}} {\sum }_{n = 0}^{N - 1} {e}^{j ( θ [ n ] - \frac{2 π kn}{N} )} , {W}_{N} [ k ] = \frac{1}{\sqrt{N}} {\sum }_{n = 0}^{N - 1} w [ n ] {e}^{- j \frac{2 π kn}{N}} .$$

However, if the allocated bandwidth is further partitioned into L subcarrier groups each of length M, and each group exhibits circularity in the frequency domain, then the same convolution property may hold in each subcarrier group, as follows:

$${R}_{M} [ k ] = {X}_{M} [ k ] {⊗}_{M} {P}_{M} [ k ] + {W}_{M} [ k ] , k = 0 , … , M - 1 , {R}_{M} [ k ] = \frac{1}{\sqrt{M}} {\sum }_{m = 0}^{M - 1} r [ m ] {e}^{- j \frac{2 π km}{M}} , {P}_{M} [ k ] = \frac{1}{\sqrt{M}} {\sum }_{m = 0}^{M - 1} {e}^{j ( θ [ m ] - \frac{2 π km}{M} )} , {W}_{M} [ k ] = \frac{1}{\sqrt{M}} {\sum }_{n = 0}^{M - 1} w [ m ] {e}^{- j \frac{2 π km}{M}} ,$$

where R_{M}[k], P_{M}[k] and W_{M}[k] are the M-point DFT of r[n], x[n] and w[n] respectively. In this way the phase noise impairment can be analyzed, either in the time domain through a point-wise multiplication, or in the frequency domain through a circular convolution, in every subcarrier group of size M.

Using one or more of the above equations for analysis of phase noise impairment, there may be one or more advantages, such as, subcarrier groups can be treated separately to estimate, and further compensate, phase noise ICI through use of a smaller DFT per each subcarrier group, hence lowering the overall complexity.

Using one or more of the above equations for analysis of phase noise impairment, there may be one or more advantages, such as, given that PN compensation is usually performed by the receiving entity after channel equalization, residual equalization errors may be different in each subcarrier group depending on the value of the channel's coherence bandwidth. Thus, it becomes desirable to estimate phase noise separately in each subcarrier group to avoid the impact of residual errors from another frequency region with a very different channel response. Further averaging of the estimations over the subcarrier groups may lead to improved frequency diversity in the PN compensation process. The size M of the subcarrier groups should be equal to, or smaller than, the channel's coherence bandwidth in order to benefit from frequency diversity when averaging the estimations over the subcarrier groups. The channel's coherence bandwidth may be assumed to be known via channel state information (CSI) feedback or direct estimation by the transmitting entity when channel reciprocity is ensured (e.g., as in Time Division Duplex, TDD, systems using the same carrier frequency for uplink and downlink).

Using one or more of the above equations for analysis of phase noise impairment, there may be one or more advantages, such as, CPE estimation may leverage the presence of legacy PT-RS signals potentially inserted in the WTRU's allocated bandwidth. When PN-induced ICI is significant, PT-RS signals may be assumed to be present in every CP-OFDM symbol to track CPE variations due to the low time-coherence of phase noise.

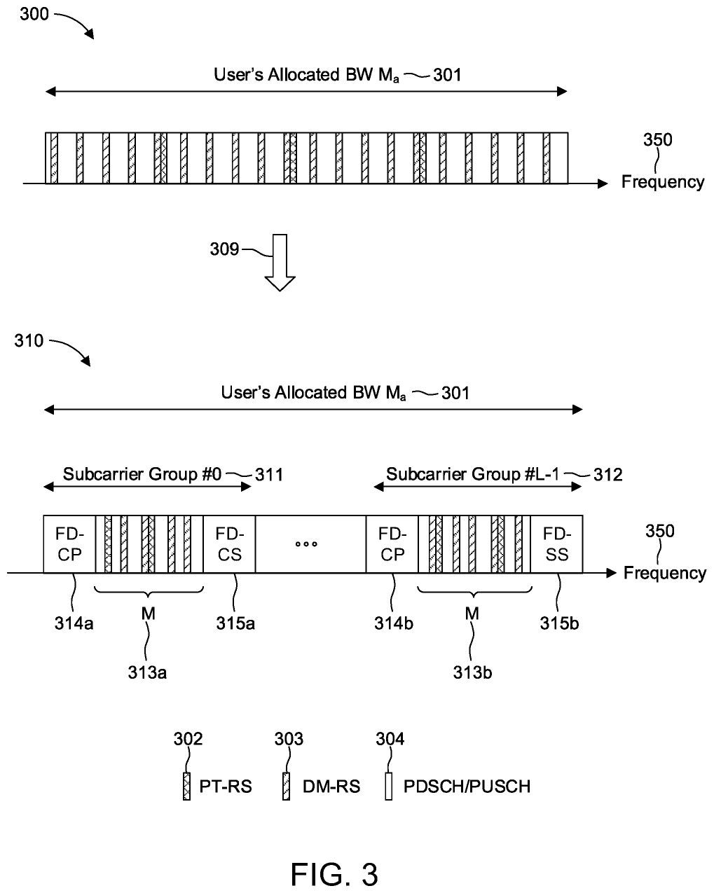

Signals in the frequency domain may be generally non-circular unless a suitable frequency-domain cyclic structure is appended or prepended to the subcarrier groups, either a cyclic prefix or a cyclic suffix (or both), resulting in the cyclic partitioning method shown herein, such as in FIG. 3.

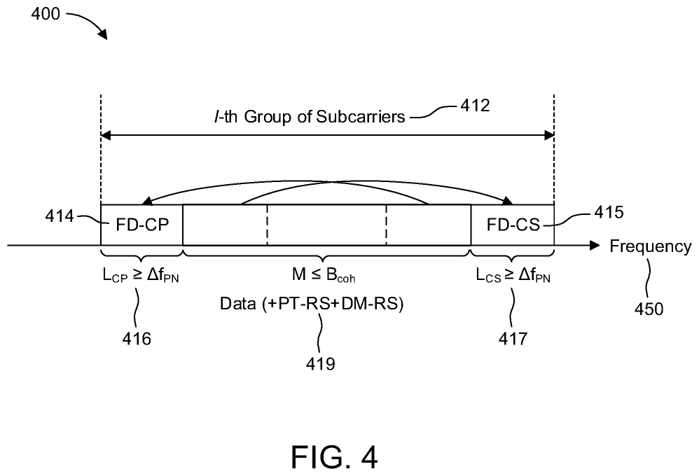

FIG. 3 illustrates an example of cyclic partitioning, where frequency 350 is shown in the horizontal axis. 300 shows a WTRU's allocated bandwidth of Mₐ subcarriers 301, with non-limiting examples of signals (e.g., PT-RS 302, DM-RS 303, PDSCH/PUSCH 304). Moving 309 to the bottom of the figure, at 310, there may be cyclic partitioning of Mₐ subcarriers 301 (e.g., a WTRU's allocated bandwidth) into L subcarrier groups (e.g., Subcarrier group #0 311, to subcarrier group #L-1 312) with a frequency-domain cyclic prefix/cyclic suffix (FD-CP, FD-CS) structure respectively prepended and appended to each of them (e.g., FD-CP 314, FD-CS 315). The details of FD-CP/CS insertion in each subcarrier group are illustrated in FIG. 4.

FIG. 4 illustrates an example of FD-CP/CS insertion in a subcarrier group. As shown at 400, there is an I-th group of subcarriers 412, with frequency 450 shown in the horizontal axis. For maximum generality, a frequency domain cyclic prefix (FD-CP) 414 and/or a frequency domain cyclic suffix (FD-CS) 415 may be prepended/appended to the subcarrier groups to achieve signal circularity. The signals within the subcarrier may be data, PT-RS, DM-RS, etc. (e.g., 419). Either one FD-CP, one FD-CS, or a combined FD-CP/CS may be preferred in practical situations. FD-CP may contain a replica of the last L_{CP} subcarriers in the subcarrier groups, and FD-CS may contain a replica of the first L_{CS} subcarriers in the subcarrier groups. The subcarrier group size, M, may be less than or equal to the channel's coherence bandwidth, B_{coh}. The length of a frequency-domain cyclic prefix, L_{CP} 416, and the length of a frequency-domain cyclic suffix, L_{CS} 417, may be greater or equal to a function of phase noise spectral width.

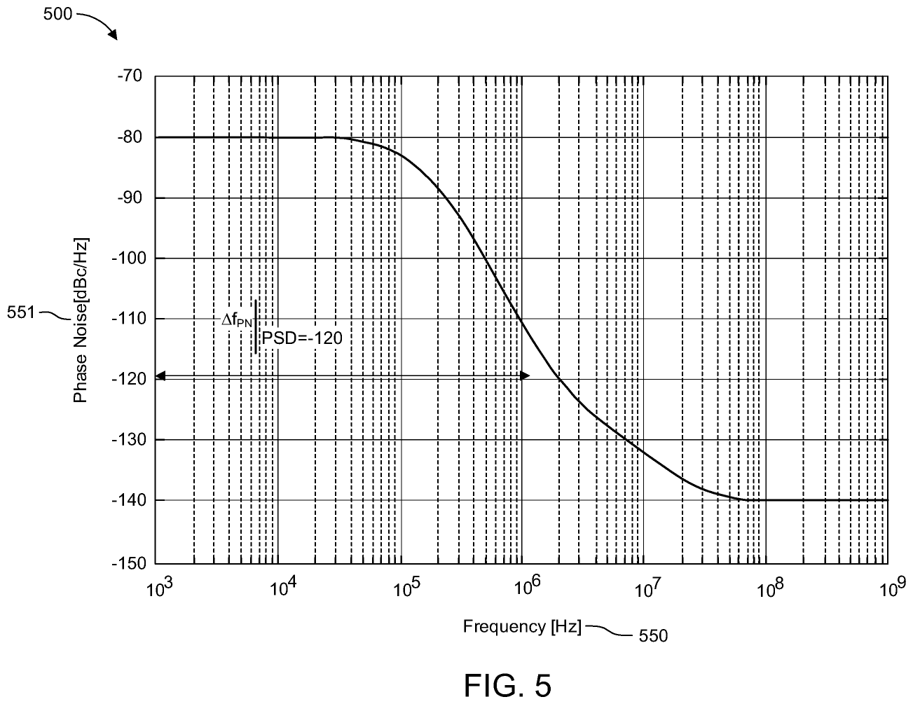

FIG. 5 illustrates an example of phase noise response showing a one-sided spectral width for −120 dBc/Hz power spectral density. As shown in 500, frequency is shown on the horizontal axis 550, and phase noise is shown on the vertical axis 551. Both L_{CP} and L_{CS} may be related to the one- or two-sided spectral width of the phase noise response observed in the entire transmit-receive transceiver chain shown in FIG. 5, as described in the following sub-sections. Δf_{PN} may denote the one-sided spectral width of phase noise for a given level, so the two-sided spectral width of phase noise may be 2Δf_{PN}. For simplicity and not intending to limit any disclosure, only relative values of Δf_{PN} and 2Δf_{PN} may be considered with respect to the subcarrier spacing.

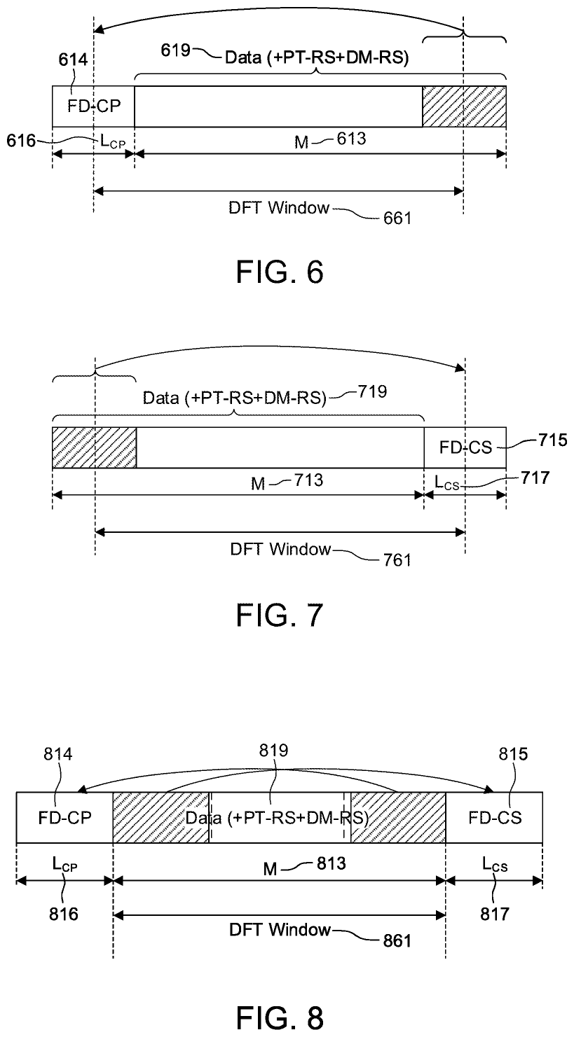

For FIG. 6, FIG. 7, and FIG. 8, frequency is shown in the horizontal axis. M may represent a region size (e.g., 613, 713, and 813).

FIG. 6 illustrates an example of a single FD-CP insertion per subcarrier group. In this case, a single FD-CP 614 with size L_{CP}≥2Δf_{PN} (relative to the subcarrier spacing) may render the subcarrier groups circular as shown in the example of FIG. 6. Subcarriers in the region of size M 613 (including the shaded region at the end) may contain data, PT-RS, DM-RS, (e.g., 619) or any other control/data signal foreseen to be mapped in that region. In some cases, the length L_{CP} 616 may be small even at very high frequencies, in the order of less than 10 coefficients. CPE may correspond to the DC component of P[k], such as P[0].

For subcarrier groups to cope with both positive and negative frequency shifts caused by phase noise, the DFT window 661 for PN compensation may start at the center of the FD-CP 614 and finish Δf_{PN} subcarriers before the end of the CP-OFDM symbol. Given this, control/data subcarriers originally scheduled in the subcarrier group may be circularly shifted L_{CP}/2 subcarriers to the right (e.g., see arrow) in the DFT window and this may be taken into account by the phase noise compensation algorithm.

FIG. 7 illustrates an example of single frequency-domain cyclic suffix (FD-CS) 715 insertion per subcarrier group. In this case, a frequency-domain cyclic suffix FD-CS 715 may perform the same role as the FD-CP as shown FIG. 6 (e.g., FIG. 6 similar description applies to FIG. 7). The FD-CS 715 size must fulfill the condition L_{CS}≥2Δf_{PN} (relative to the subcarrier spacing) to attain circularity, and control/data subcarriers 719 originally scheduled in the subcarrier group may be circularly shifted L_{CP}/2 subcarriers to the left in the DFT window (e.g., see arrow).

The advantage of the use of a single FD-CP or FD-CS is its similarity with the already known CP insertion techniques employed in CP-OFDM, at the cost of a circular shift of half the length of FD-CP or FD-CS in the control/data information contained in the DFT window (e.g., 661, 761). However, as PN compensation is performed after channel equalization, in some cases, this shift may not impact performance as long as PN compensation considers a correct subcarrier ordering.

FIG. 8 illustrates an example of combined FD-CP/CS insertion per subcarrier group. This comprises a more general case where both a FD-CP 814 and a FD-CS 815 are appended and prepended respectively to the subcarrier groups (e.g., M 813), as shown in FIG. 8. Assuming a symmetrical phase noise response, the FD-CP/CS must fulfill the condition (relative to the subcarrier spacing): L_{CP}=L_{CS}≥Δf_{P}N. The advantage of this case is that no re-ordering is needed when performing PN compensation in each subcarrier group, and the DFT window 861 contains the original subcarriers with no shifts.

Without loss of generality, examples disclosed herein may relate to a generic insertion of FD-CP/CS to the subcarrier groups either corresponding to a single FD-CP, a single FD-CS, or a combined FD-CP/CS depending on the implementations. The lengths of FD-CP, FD-CS and the size M may be adapted to the phase noise and channel conditions on a per-WTRU basis in the relevant part of the carrier bandwidth.

The one- or two-sided spectral width of phase noise may be either pre-determined by the transceiver or reported by a receiving entity. The phase noise spectral width will generally exhibit the combined PN characteristics of the transmitting entity and receiving entity oscillators.

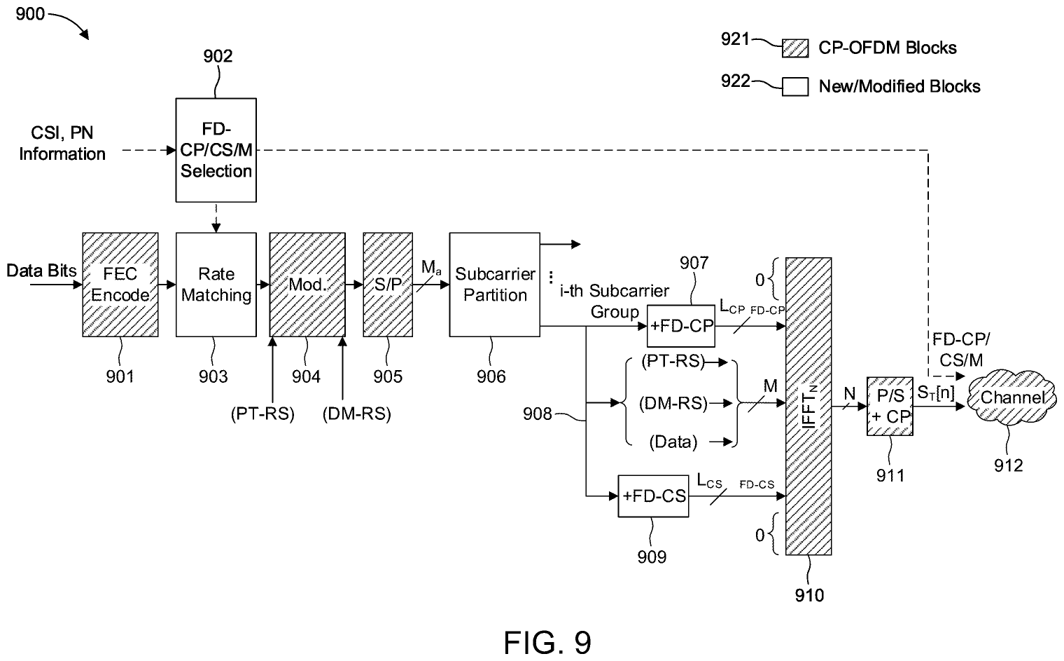

FIG. 9 illustrates an example of transmit processing for generation of CP-OFDM signals based on phase noise cyclic partitioning. To illustrate one or more of the techniques disclosed herein, the process for transmission of CP-OFDM signals based on phase noise cyclic partitioning may be illustrated in the example of FIG. 9. Regular (e.g., legacy) processing for generation of CP-OFDM signals may be depicted in shaded blocks (e.g., 921) while new or modified blocks may be depicted in blocks without any fill (e.g., 922). The transmission steps may be focused on the generation of a CP-OFDM signal for a given WTRU, but all the explanations may be extended to the case of multiple WTRUs that are frequency-multiplexed in the same CP-OFDM symbol. Transmission may also be based on a single Transmit-Receive Point (TRP), but the techniques disclosed herein may be applied to the case of having multiple TRPs as exemplified herein. As discussed herein, one or more TRPs may be part of a base station.

As disclosed herein (e.g., below), there may be techniques in the processing steps required for generation of a CP-OFDM symbol based on the disclosed examples of phase noise cyclic partitioning method described herein.

As shown in FIG. 9, data bits may go to FEC encoding 901 and deliver one or more symbols. In an example, each symbol would be processed individually. For FD-CP/C S/M selection 902, this block performs selection of the lengths of the FD-CP and/or FD-CS fields and the size M of the subcarrier groups. FD-CP/CS/M selection may follow the guidelines explained herein (e.g., phase noise cyclic partitioning method), namely, M may be equal or smaller than the channel's coherence bandwidth experienced by the WTRU and the lengths of FD-CP and/or FD-CS should comply with any of the criteria stated herein in this or other examples (e.g., single FD-CP insertion per subcarrier group, single FD-CS insertion per subcarrier group, combined FD-CP/CS insertion per subcarrier group). If the channel's coherence bandwidth is larger than the WTRU's allocated bandwidth then the transmitting entity may decide not to perform phase noise cyclic partitioning, as the benefit of having a FD-CP or FD-CS vanishes in this case (e.g., and the receiving entity may perform ICI compensation based on a particular implementation without the need for any changes on the transmitted signal). Otherwise, the block delivers the number of subcarrier groups, its size M, and the lengths of FD-CP and/or FD-CS fields for use by the transmitting entity.

The values of M and the lengths of FD-CP and/or FD-CS may be selected among the combinations allowed in a codebook of a-priori defined values, that the transmitting entity and the receiving entity may know in advance to properly cope with any expected phase noise characteristics and channel coherence bandwidths.

A factor governing the phase noise may be the quality of the oscillators at the transmitting and at the receiving device. In some cases, this factor may be important relative to other factors, as disclosed herein. In more precise terms, the oscillator, the phase-locked loop, and the whole process of carrier generation may have an impact on phase noise, though for the sake of exposition, we are using the terminology of oscillator quality. The transmitting entity may have the knowledge of its oscillator quality but may not have the information about the receiving entity oscillator. In some cases, there may be some minimal requirements to be satisfied though knowledge of actual oscillator quality lets the transmitting entity choose appropriately the parameter set for PN compensation achieving the trade-off of overhead and performance.

The selection may be based on the channel state information and/or any known PN information of the transmit-receive link, including, for example, the PN spectral width or the PN capabilities of the receiving entity. PN information may be obtained from feedback reports sent by the receiving entity, or it can be obtained through measurements performed by the transmitting entity on signals received from the peer node in the opposite link direction, such as if/when the receiving entity is acting as a transmitting entity. Given that PN is the result of the combined impairments from the transmit and receive radio-frequency chain, it may be possible to infer its characteristics either on the downlink or the uplink provided that the same pair of transmitting/receiving nodes is considered in each case.

Rules for selection of FD-CP/CS/M may be based on a semi-static PN configuration message received by higher-layer signaling, or on dynamic policies dependent on the received feedback and/or triggered by specific events previously configured by higher-layer signaling. Selection may also consider the overhead posed by the FD-CP/CS fields to minimize its impact on the available resources.

In order to better react to the phase noise experienced by the receiving entity, the transmitting entity may take into account an indication received from the peer entity informing about a high phase noise on reception, which may, for example, trigger an increase in the FD-CP and/or FD-CS lengths to better absorb ICI. Such indication may be sent by the receiving entity in an uplink shared control or data channel (e.g., 5G NR PUCCH or PUSCH), or by means of a Medium Access Control (MAC) Control Element (CE), MAC CE. The indication may be based on a phase noise ICI power exceeding a threshold set via higher-layer signaling or configured by the transmitting entity in a phase noise configuration message, for example in the downlink shared control or data channel (e.g., PDCCH or PDSCH) or by means of a MAC CE.

CSI information may comprise any indication of the channel's quality measured by the receiving entity and reported back to the transmitting entity, such as Channel Quality Indicator (CQI) information per frequency sub-bands, signal-to-noise ratio (SNR), or an explicit measurement of the channel's coherence bandwidth. CSI may also be obtained by the transmitting entity by measurements performed on the opposite link direction when channel reciprocity conditions are met (e.g., when the downlink and uplink carrier frequencies are the same, as in TDD systems).

PN information may include, without limitation, any of the following metrics in any suitable units or according to any pre-defined quantization scales: an indication of the phase noise spectral width expressed (e.g., in Hz or number of subcarriers); an indication expressing the number of non-negligible ICI coefficients that describe phase noise at the current operating conditions; the power of the experienced phase noise impairment; an indication of the post-detection SNR measured at the receiving entity after equalization and phase noise compensation; a residual mean-squared error (MSE) of the detection at the output of the phase noise compensation algorithm; and/or, Error vector magnitude (EVM) of the constellation as seen at the receiving entity after equalization.

Other measurements may also be contemplated without departure from the ideas contained in the examples provided herein.

Any PN information reported by the receiving entity may be sent on a periodic, semi-periodic, on-demand or event-triggered fashion. Some of the above PN information may be inferred by the transmitting entity from measurements performed on the opposite link direction, such as the phase noise spectral width, or the number of non-negligible ICI coefficients that describe phase noise.

Information about the PN capabilities of the receiving entity may be obtained by means of feedback sent by the receiving entity node upon session establishment. PN capabilities may comprise, for example, a radio-frequency category or oscillator quality class, or an indication about the amount of phase noise that the receive device is expected to experience at typical operating conditions (e.g., temperature, power or cell load), measured as phase noise spectral width, number of non-negligible ICI coefficients characterizing phase noise for a given numerology or set of numerologies, or any other similar information. PN capabilities may also be obtained from higher-layer signaling in a static or dynamic way according to the application requirements or retrieved from a database storing the phase noise characteristics of the receiving entity.

The Rate Matching block 903 of the example shown in FIG. 9, after obtaining the selected values of L_{CP}, L_{CS} and M from the FD-CP/CS/M selection block 902, may adjust the net amount of data information that can be mapped to subcarriers after considering the overhead posed by FD-CP and/or FD-CS, calculated as o=(L_{CP}−L_{CS})/M, together with the overhead posed by any other control and reference signals. The Rate Matching block may operate after a Forward Error Correction (FEC) encoding block 901 aimed to provide redundancy to the information for improved resiliency against channel impairments, and adjusts the amount of parity information at its output to match the available physical resources in the CP-OFDM symbol.

After modulating 904 the rate-matched data bits to complex constellation symbols and performing serial-to-parallel (S/P) conversion 905, the subcarrier partitioning block 906 may take as inputs the complex control and data symbols to be mapped on physical resources, and partitions the whole set of size Mₐ into one or more subcarrier groups each of length M. Control and reference signals shall be included within the useful part of the subcarrier groups with length M, including, for example, PT-RS and/or DM-RS from 5G NR. Afterwards, FD-CP 907 and FD-CS 909 fields containing a replica of the last or the first complex symbols respectively may be prepended or appended to each of the subcarrier groups, in order to preserve circularity in the frequency domain and allow DFT-based PN compensation per each subcarrier group.

The remaining steps for transmission may include an inverse FFT 910 of size N to generate the time-domain signal S_{T} [n], parallel-to-serial (P/S) conversion 911, and/or addition of time-domain cyclic prefix to absorb multipath caused by the channel's delay spread and thus provide signal circularity in the time domain.

The transmitting entity may signal 912 to the receiving entity an indication of the lengths used for FD-CP and/or FD-CS, and the value of M, employed in one or several consecutive CP-OFDM symbols. A single FD-CP/CS/M indication may be sent comprising the required parameters, or several separate indications may also contain the corresponding parameters depending on the implementation. The transmitting entity may send 912 an index corresponding to a pre-defined codebook containing all possible combinations of FD-CP and/or FD-CS lengths, and values of M, so that the receiving entity may unambiguously obtain the selected parameters. Blind detection of these parameters may also be possible by the receiving entity to avoid explicit signaling of these parameters.

In a compatible design, the network can configure a mapping table where each row provides a suitable combination of parameter set, namely the lengths of FD-CP/CS/M. The network chooses a suitable configuration for PN compensation at the receiving entity and indicates its row index to the WTRU. Pre-configuration may indicate to WTRU whether the indication for PN parameter set will be dynamic or static. For the dynamic case, the indication of the selected configuration can be transmitted in each DCI providing a lot of flexibility and reactivity to adapt with respect to system and transmission parameters. For the static or semi-static case, the PN parameter set indication can be provided as part of Radio Resource Control (RRC) signaling or MAC-CE.

The same mechanism and mapping structure can be used by WTRU to provide feedback to the network of what parameter set it would like to receive for its PN compensation. The WTRU may provide the indication of its desired PN parameter set as part of higher layer signaling.

Signaling indications may be sent periodically, semi-periodically, on-demand, or triggered by events like, such as a change in the channel's coherence bandwidth, or if the phase noise conditions in the transmit-receive chain change substantially.

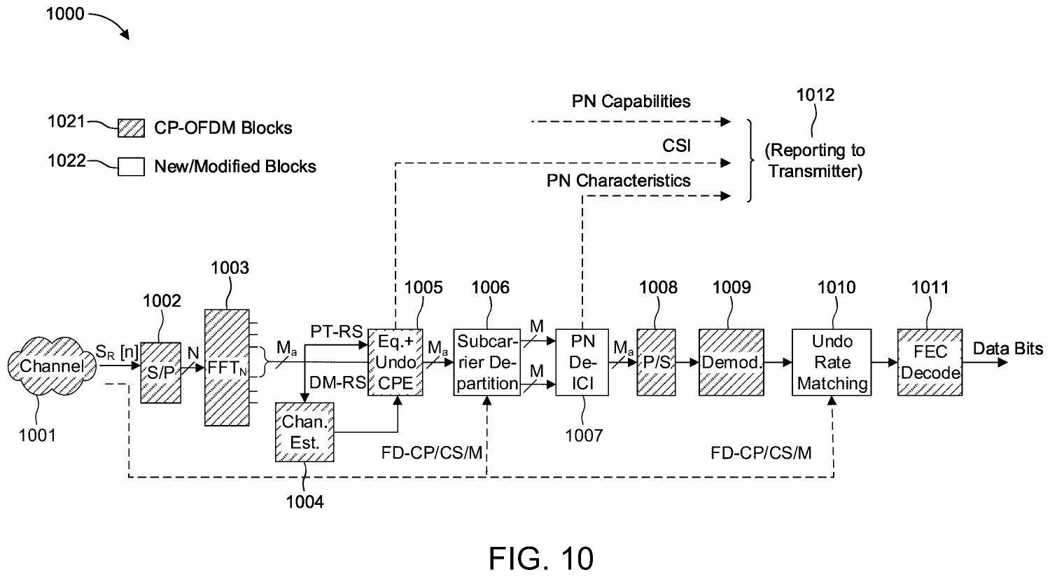

FIG. 10 illustrates an example process of receiving CP-OFDM signals based on phase noise cyclic partitioning. The processing steps for reception of CP-OFDM signals based on phase noise cyclic partitioning may be illustrated in FIG. 10. Without loss of generality, reception of signals from a single TRP may be assumed but the explanation can be easily applied to the case of multiple TRPs, as described herein. Reception steps may be focused on a given WTRU, but all the explanations may be easily extended to the case of multiple WTRUs that are frequency-multiplexed in the same CP-OFDM symbol. Note, in the example of FIG. 10, regular (e.g., legacy) processing of signals may be depicted in shaded blocks (e.g., 1021) while new or modified blocks may be depicted in blocks without any fill (e.g., 1022).

A symbol(s) may be received 1001, and after serial-to-parallel conversion 1002 and performing an N-point FFT 1003, the received symbol may be equalized after channel estimation 1004 aided by, such as a DM-RS signal (e.g., in 5G NR). CPE compensation 1005 may then be performed aided by, for example, a PT-RS signal in 5G NR, and subcarriers may be de-partitioned 1006 by concatenating the M subcarrier groups and removing the FD-CP and/or FD-CS fields. The lengths L_{CP}, L_{CS} and M may be assumed to be obtained via signaling from the transmitting entity side, higher-layer indications, or through blind detection. Signaling from the transmitting entity may be referred to a pre-defined codebook containing all possible combinations of FD-CP and/or FD-CS lengths, and values of M, so that the receiving entity may unambiguously obtain the selected parameters.

At the output of this block, the contents of the M useful subcarriers in each subcarrier group may be delivered to the PN de-ICI block 1007 for ICI compensation.

Regarding the phase noise de-ICI block 1007, this block may leverage signal circularity by performing estimation and subsequent cancellation of the phase noise ICI impairment individually for each of the subcarrier groups, and further averaging over the subcarrier groups for extra frequency diversity. A measurement of the residual phase noise power after the de-ICI process may be performed to assess, for example, whether a high phase noise is present so that the transmitting entity performs corrective actions to further reduce phase noise. For example, if the residual phase noise power exceeds a threshold, the receiving entity may send an indication to the transmitting entity signaling a high phase noise and containing some phase noise-related information, like, such as the phase noise spectral width, the number of non-negligible ICI coefficients of the phase noise response, a post-detection SNR, the residual MSE of the detection after ICI mitigation, the EVM of the constellation after equalization, and/or similar ones.

As an example of de-ICI algorithm, there may be one or more steps that may be followed by the receiving entity to perform PN-induced ICI compensation.

First, a device may perform equalization and CPE compensation of the received signal to yield the complex symbols in frequency domain {Xₖ⁽⁰⁾,k=0, . . . , N−1}. These symbols may generally suffer from phase noise-induced ICI.

Second, the device may obtain the values of L_{CP},L_{CS} and M via signalling or blind detection, take the l-th group of M subcarriers, and discard the FD-CP/CS fields to yield the symbols in the l-th subcarrier group {X_{k,l}⁽⁰⁾,k=0, . . . , M−1}, and its time-domain counterpart {rᵢ[m]=DFT_{M}⁻¹[X_{k,l}⁽⁰⁾], m=0, . . . , M−1}.

Third, assuming the l-th subcarrier group symbols {X_{k,l}⁽⁰⁾,k=0, . . . , M−1} are already obtained in a previous iteration, there may be one or more additional steps for ICI compensation. The device may demodulate the data symbols in X_{k,l}⁽ⁱ⁾ and obtain hard-decision estimates \hat{X}_{k,l}⁽ⁱ⁾ by approximating to the closest constellation symbols. The device may reconstruct the M-point time-domain signal \hat{x}ₗ⁽ⁱ⁾[m]=DFT_{M}⁻¹{\hat{X}_{k,l}⁽ⁱ⁾}, m=0, . . . , M−1. The device may estimate the time-domain phase noise impairment by point-wise division of the time-domain received signal and the reconstructed signal, \hat{p}ₗ⁽ⁱ⁾[m]=rₗ[m]/\hat{x}ₗ⁽ⁱ⁾[m]. The device may obtain the phase noise coefficients \hat{P}_{k,l}⁽ⁱ⁾=DFT_{M}{\hat{p}ₗ⁽ⁱ⁾[m]} and truncate to (at most) L_{CP}+L_{CS}+1 terms by setting the remaining terms to zero. The device may remove ICI by performing an M-point circular deconvolution to yield X_{k,l}⁽ⁱ⁺¹⁾=X_{k,l}⁽⁰⁾⊗_{M}{\hat{P}_{(-k mod M),l}^{*(i)}}, where a mod b is the modulo operation that yields the remainder of the division a/b. The device may calculate the root mean square of the residual phase noise

$$\sqrt{\frac{1}{M} {\sum }_{m = 0}^{M - 1} {\vert {X}_{k , l}^{( i + 1 )} - {X}_{k , l}^{( i )} \vert}^{2}} ,$$

and repeat one or more previous steps until it is lower than a pre-determined threshold E. In such case, take \hat{P}_{k,l}⁽ⁱ⁾ as estimates of the ICI coefficients in the l-th subcarrier group.

Fourth, the second and third steps may be repeated for each subcarrier group, average out the ICI coefficients in all the subcarrier groups after undoing the residual CPE that may remain after equalization, and extend its size to N thus yielding:

$${\hat{P}}_{k} = \{ \begin{matrix}\frac{1}{L} {\sum }_{l} {\hat{P}}_{k , l}^{( i )} {e}^{- {jCPE}_{res , l}} , & k = 0 , … , M - 1 \\ 0 , & k = M , … , N - 1\end{matrix}$$

where CPE_{res,l} stands for the residual phase at the subcarrier group l. This term may be estimated, for example, from the residual phase of the DC component in the l-th phase noise response, CPE_{res,l}=Arg{\hat{P}_{0,l}⁽ⁱ⁾}. The overall remaining CPE can be then further estimated across the subcarrier groups and compensated as in the first step.

Fifth, the device may obtain the PN-compensated signal via an N-point circular convolution Xₖ⁽⁰⁾ of \hat{P}_{(-k mod N)}^{*,} i.e., \hat{X}ₖ=Xₖ⁽⁰⁾⊗_{N} \hat{P}_{(-k mod N)}^{*,} k=0, . . . , N−1.

The aforementioned example process is just an example of ICI compensation algorithm, and other possibilities exist depending on implementations. Its complexity C_{deICI}, measured as the number of complex multiplications, may be given by:

$${𝒞}_{deICI} = \frac{{M}_{a}}{M} {N}_{i t} \{ 2 M log M + M + M ( 2 Δ {f}_{PN} + 1 ) + {𝒞}_{{f}_{QAM}} \} = {M}_{a} {N}_{i t} \{ 2 ( log M + Δ {f}_{PN} + 1 ) + \frac{{𝒞}_{{f}_{QAM}}}{M} \} ,$$

where f_{QAM}(·) denotes the hard-decision function, Nᵢₜ is the number of iterations, Mₐ is the number of subcarriers scheduled for the WTRU, Δf_{PN} if the one-sided spectral width of phase noise, and [symbol] _{f}_{_{QAM}}(·) denotes the complexity of f_{QAM}.

As shown in the example of FIG. 10, after parallel-to-serial conversion 1008 and demodulation 1009 of the subcarrier data, the Rate Matching operation performed at transmission may be undone 1010 to recover the original bits. The Rate Matching operation may be aided by an indication of the lengths L_{CP}, L_{CS} and M, obtained via signaling the remote entity, higher-layer signaling, or blind detection. The output of this block 1010 comprises the received encoded bits which are then FEC-decoded 1011 to recover the original information bits (e.g., data bits).

In addition to CSI information, the receiving entity may report 1012 to the transmitting entity information about the amount of phase noise experienced in the detection, including for examples, an indication of high phase noise conditions, some phase noise-related metrics like, for example, phase noise spectral width, number of non-negligible ICI coefficients of the phase noise response, post-detection SNR, or residual MSE of the detection, and a phase noise capabilities report. These metrics may be sent on a periodic, semi-periodic, on-demand, or event-triggered basis. Event-triggered reporting may be based on one or several conditions to be met upon reception, such as a residual phase noise ICI power being above a pre-determined threshold, which may be configured via higher-layer signaling or in a phase noise configuration information message sent by the transmitting entity. Periodic, semi-periodic or on-demand reporting may also be based on a phase noise configuration received via higher-layer signaling or in a phase noise configuration information message sent by the transmitting entity.

The phase noise capabilities of the receiving entity may comprise, for example, a radio-frequency category or oscillator quality class, or an indication about the amount of phase noise expected to experience at typical operating conditions (e.g., temperature, power or cell load), measured as a phase noise spectral width, a number of non-negligible ICI coefficients characterizing phase noise for a given numerology or set of numerologies, or any other similar information.

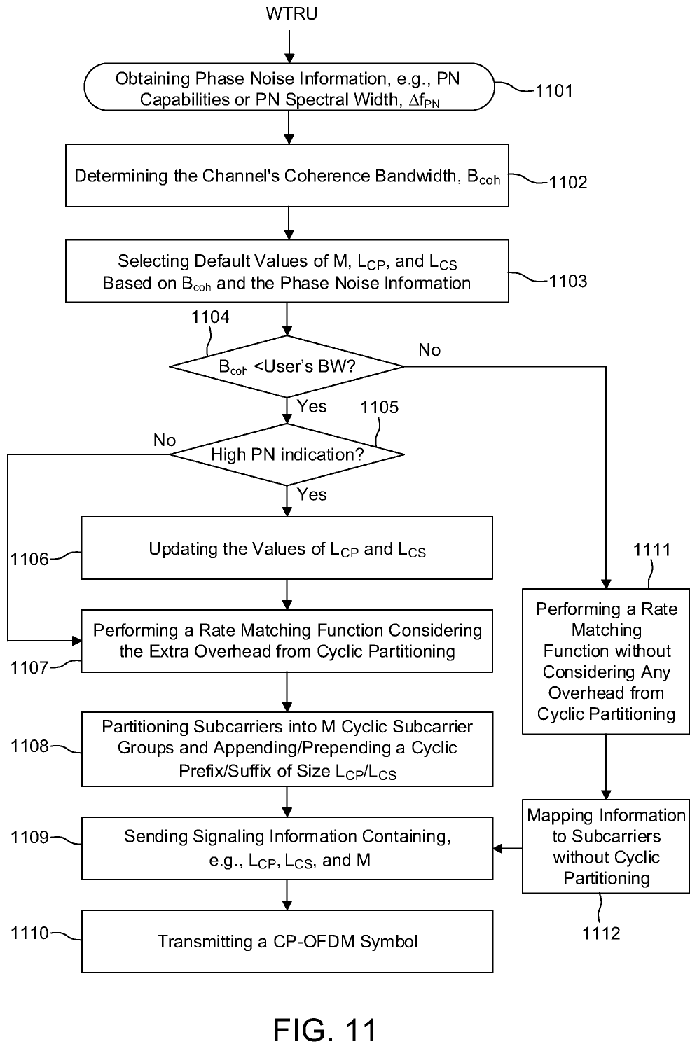

FIG. 11 illustrates an example procedure for the transmission of CP-OFDM symbols based on phase noise cyclic partitioning. In the example method shown, a first WTRU or set of first WTRUs transmitting CP-OFDM symbols to a second WTRU or set of second WTRUs, may perform one or more of the following: at 1101, obtaining a phase noise information characterizing the amount of phase noise experienced in the communications link (e.g., phase noise capabilities or phase noise spectral width, Δf_{PN}); at 1102, determining the channel's coherence bandwidth, B_{coh}; at 1103, selecting default values of a subcarrier group size, M, the length of a frequency-domain cyclic prefix, L_{CP}, and the length of a frequency-domain cyclic suffix, L_{CS}, based on B_{coh} and the phase noise information; at 1104, if the channel's coherence bandwidth is lower than the WTRU's allocated bandwidth, in order to adapt the cyclic partitioning parameters M, L_{CP} and L_{CS} to the instantaneous conditions, and/or at 1105, determining if a high phase noise indication is reported by the second WTRU; at 1106 (e.g., if 1104 and 1105 are yes) updating the values of L_{CP} and L_{CS} based on a high phase noise indication received from the second WTRU; at 1107, performing a Rate Matching function to adjust the amount of data to be mapped to physical resources available after considering the frequency-domain cyclic prefix and/or cyclic suffix fields; at 1108, partitioning the subcarriers into M subcarrier groups, and appending/prepending a frequency-domain cyclic prefix and/or cyclic suffix to each subcarrier group; at 1109, sending signaling information containing, such as values of M, L_{CP} and L_{CS}; and/or, at 1110, transmitting the CP-OFDM symbol. If, at 1104, the result is no, then at 1111, performing a rate matching function without considering any overhead from cyclic partitioning; at 1112, mapping information to subcarriers without cyclic partitioning, which would then lead to 1109, sending signaling information as disclosed herein. At 1105, if there is not a high PN indication, the WTRU proceed directly to perform a Rate Matching function at 1107.

In one instance of a transmission procedure described herein (e.g., with respect to any figure, description, or example herein, such as FIG. 11, 12, 13), the phase noise information may be obtained/sent via higher-layer signaling (e.g., via RRC phase noise configuration information).

In one instance of a transmission procedure described herein (e.g., with respect to any figure, description, or example herein, such as FIG. 11, 12, 13), the phase noise information may be obtained from an indication sent by the second WTRU via, e.g., an uplink shared control or data channel, (e.g., PUCCH or PUSCH), or by means of a MAC CE.

In one instance of a transmission procedure described herein (e.g., with respect to any figure, description, or example herein, such as FIG. 11, 12, 13), the phase noise information may be obtained by the first WTRU or set of first WTRUs by measuring the amount of phase noise experienced in the opposite link direction between the first WTRU or set of first WTRUs and the second WTRU or set of second WTRUs.

In one instance of a transmission procedure described herein (e.g., with respect to any figure, description, or example herein, such as FIG. 11, 12, 13), the phase noise information may comprise an indication from the second WTRU or set of second WTRUs containing the lengths of the frequency-domain cyclic prefix and cyclic suffix, and the subcarrier group size, to be employed by the first WTRU or set of first WTRUs in the next CP-OFDM symbol or set of CP-OFDM symbols.

In one instance of a transmission procedure described herein (e.g., with respect to any figure, description, or example herein, such as FIG. 11, 12, 13), the phase noise information may comprise an indication from the second WTRU or set of second WTRUs containing the preferred subcarrier partitioning, by means of an index to a codebook of a-priori defined combinations of lengths of the frequency-domain cyclic prefix and cyclic suffix, and subcarrier group sizes, that are known to the first WTRU or set of first WTRUs and the second WTRU or set of second WTRUs.

In one instance of a transmission procedure described herein (e.g., with respect to any figure, description, or example herein, such as FIG. 11, 12, 13), the phase noise capabilities may comprise an indication of a-priori known radio-frequency category or oscillator quality class among a set of a-priori categories or classes, or an indication of the amount of phase noise experienced at typical operating conditions, (e.g., temperature, power and/or cell load).

In one instance of a transmission procedure described herein (e.g., with respect to any figure, description, or example herein, such as FIG. 11, 12, 13), the amount of phase noise may be expressed as a phase noise spectral width measured in units of Hz or number of subcarriers for a given numerology or set of numerologies.

In one instance of a transmission procedure described herein (e.g., with respect to any figure, description, or example herein, such as FIG. 11, 12, 13), the amount of phase noise may be expressed as the number of non-negligible ICI coefficients in the phase noise spectral response at the current operating conditions.

In one instance of a transmission procedure described herein (e.g., with respect to any figure, description, or example herein, such as FIG. 11, 12, 13), the amount of phase noise may be expressed as the power of the experienced phase noise impairment in Watts, milliwatts, dBW, dBm, or any other suitable unit.

In one instance of a transmission procedure described herein (e.g., with respect to any figure, description, or example herein, such as FIG. 11, 12, 13), the amount of phase noise may be expressed as an indication of the post-detection signal-to-noise ratio measured at the receiving entity after equalization and phase noise compensation.

In one instance of a transmission procedure described herein (e.g., with respect to any figure, description, or example herein, such as FIG. 11, 12, 13), the amount of phase noise may be expressed as the residual mean-squared error of the detection at the output of the phase noise compensation algorithm.

In one instance of a transmission procedure described herein (e.g., with respect to any figure, description, or example herein, such as FIG. 11, 12, 13), the amount of phase noise may be expressed as the error vector magnitude of the constellation as seen at the receiving entity after equalization.

In one instance of a transmission procedure described herein (e.g., with respect to any figure, description, or example herein, such as FIG. 11, 12, 13), the high phase noise indication may be reported by the second WTRU in an uplink shared control or data channel, (e.g., PUCCH or PUSCH), or by means of a MAC CE.

In one instance of a transmission procedure described herein (e.g., with respect to any figure, description, or example herein, such as FIG. 11, 12, 13), the high phase noise indication may be reported by the second WTRU based on a phase noise threshold sent by the first WTRU or set of first WTRUs in a phase noise configuration message, (e.g., in a downlink shared control or data channel, PDCCH or PDSCH, or by means of a MAC CE).

In one instance of a transmission procedure described herein (e.g., with respect to any figure, description, or example herein, such as FIG. 11, 12, 13), the channel's coherence bandwidth may be obtained from a channel state information indication reported by the second WTRU, or may be measured by the first WTRU or set of first WTRUs on a signal received from the second WTRU when the uplink and downlink carrier frequencies are the same.

In one instance of a transmission procedure described herein (e.g., with respect to any figure, description, or example herein, such as FIG. 11, 12, 13), the subcarrier group size M may be equal to, or lower than, the channel's coherence bandwidth.

In one instance of a transmission procedure described herein (e.g., with respect to any figure, description, or example herein, such as FIG. 11, 12, 13), the frequency-domain cyclic prefix comprises a replica of the last L_{CP} complex subcarrier amplitudes in each subcarrier group that are prepended to provide signal circularity in the frequency domain.

In one instance of a transmission procedure described herein (e.g., with respect to any figure, description, or example herein, such as FIG. 11, 12, 13), the frequency-domain cyclic suffix comprises a replica of the first L_{CS} complex subcarrier amplitudes in each subcarrier group, that are appended to provide signal circularity in the frequency domain.

In one instance of a transmission procedure described herein (e.g., with respect to any figure, description, or example herein, such as FIG. 11, 12, 13), the length of the frequency-domain cyclic prefix can be zero, and the length of the frequency-domain cyclic suffix can be equal to the two-sided phase noise spectral width expressed in number of subcarriers.

In one instance of a transmission procedure described herein (e.g., with respect to any figure, description, or example herein, such as FIG. 11, 12, 13), the length of the frequency-domain cyclic suffix can be zero, and the length of the frequency-domain cyclic prefix can be equal to the two-sided phase noise spectral width expressed in number of subcarriers.

In one instance of a transmission procedure described herein (e.g., with respect to any figure, description, or example herein, such as FIG. 11, 12, 13), the length of the frequency-domain cyclic prefix and the frequency-domain cyclic suffix can be both equal to the one-sided phase noise spectral width expressed in number of subcarriers.

In one instance of a transmission procedure described herein (e.g., with respect to any figure, description, or example herein, such as FIG. 11, 12, 13), the Rate Matching function may consider the overhead posed by the frequency-domain cyclic prefix and/or frequency-domain cyclic suffix when calculating the amount of data information after Forward Error Correction coding that can be mapped to physical available resources.

In one instance of a transmission procedure described herein (e.g., with respect to any figure, description, or example herein, such as FIG. 11, 12, 13), the signaling information may comprise an indication of the lengths of the frequency-domain cyclic prefix and cyclic suffix, and the subcarrier group size, to be employed in the next CP-OFDM symbol or set of CP-OFDM symbols.

In one instance of a transmission procedure described herein (e.g., with respect to any figure, description, or example herein, such as FIG. 11, 12, 13), the signaling information may comprise an index to a codebook of a-priori defined combinations of lengths of the frequency-domain cyclic prefix and cyclic suffix, and subcarrier group sizes, that must be known to the first WTRU or set of first WTRUs and the second WTRU or set of second WTRUs for unambiguous detection.

In one instance of a transmission procedure described herein (e.g., with respect to any figure, description, or example herein, such as FIG. 11, 12, 13), the signaling information may be sent by the first WTRU or set of first WTRUs in a periodic, semi-periodic, on-demand, or event-based fashion, with a periodicity obtained via higher-layer signaling or received from a second WTRU or set of second WTRUs in a phase noise configuration message via, (e.g., a downlink shared control or data channel, PDCCH or PDSCH, or a MAC CE).

In one instance of a transmission procedure described herein (e.g., with respect to any figure, description, or example herein, such as FIG. 11, 12, 13), the event for triggering the signaling information may be based on, for example, a variation in the channel's coherence bandwidth above a first threshold, or a variation in the phase noise spectral width above a second threshold.

In one instance of a transmission procedure described herein (e.g., with respect to any figure, description, or example herein, such as FIG. 11, 12, 13), the first WTRU is a base station equipment and the second WTRU is a UE in the downlink of a wireless communication system.

In one instance of a transmission procedure described herein (e.g., with respect to any figure, description, or example herein, such as FIG. 11, 12, 13), the set of first WTRUs are multiple transmit-receive points in the downlink of a multi-TRP wireless communication system.

In one instance of a transmission procedure described herein (e.g., with respect to any figure, description, or example herein, such as FIG. 11, 12, 13), the first WTRU and the second WTRU are UEs in the sidelink of a wireless communication system.

In one instance of a transmission procedure described herein (e.g., with respect to any figure, description, or example herein, such as FIG. 11, 12, 13), the first WTRU is a UE and the second WTRU is a base station equipment in the uplink of a wireless communication system.

In one instance of a transmission procedure described herein (e.g., with respect to any figure, description, or example herein, such as FIG. 11, 12, 13), the set of second WTRUs are multiple transmit-receive points in the uplink of a multi-TRP wireless communication system.

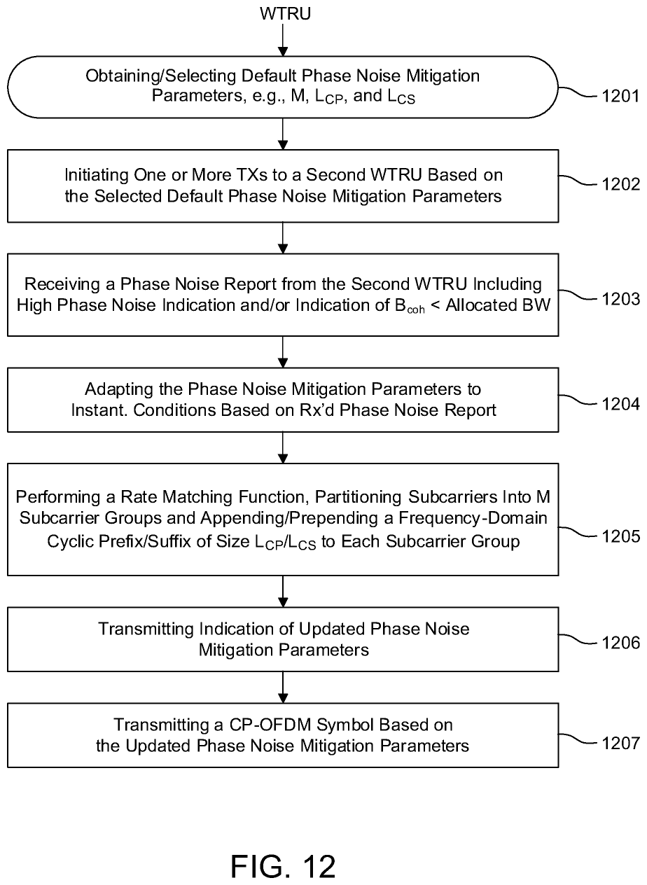

FIG. 12 illustrates an example procedure for the transmission of CP-OFDM symbols based on phase noise cyclic partitioning. In this example, a first WTRU or set of first WTRUs transmitting CP-OFDM symbols to a second WTRU or set of second WTRUs, may perform one or more of the following: initially, at 1201, the first WTRU(s) may obtain/select default phase noise mitigation parameters (e.g., of M, L_{CP} and L_{CS};); at 1202, the first WTRU(s) may initiate one or more transmissions to one or more second WTRU(s) based on selection of default phase noise mitigation parameters, such as default values of a subcarrier group size, M, the length of a frequency-domain cyclic prefix, L_{CP}, and the length of a frequency-domain cyclic suffix, L_{CS}; at 1203, the first WTRU(s) may receive a phase noise report from the second WTRU including any of a high phase noise indication and an indication of channel's coherence bandwidth lower than the second WTRU's allocated bandwidth; at 1204, the first WTRU(s) may adapt the cyclic partitioning parameters M, L_{CP} and L_{CS} to the instantaneous conditions based on received phase noise report (e.g., a high phase noise indication), from the second WTRU; at 1205, the first WTRU(s) may perform a Rate Matching function, partitioning the subcarriers into M subcarrier groups, and appending/prepending a frequency-domain cyclic suffix/prefix to each subcarrier group; at 1206, the first WTRU(s) may transmit updated parameters, such as sending signaling information comprising parameters, such as values of M, L_{CP} and L_{CS}; and/or, at 1207, the first WTRUs may transmit a CP-OFDM symbol based on the updated phase noise mitigation parameters.

In one instance of a transmission procedure described herein (e.g., with respect to any figure, description, or example herein, such as FIG. 11, 12, 13), wherein the phase noise report may comprise an indication from the second WTRU or set of second WTRUs containing the lengths of the frequency-domain cyclic prefix and cyclic suffix, and the subcarrier group size, to be employed by the first WTRU or set of first WTRUs in the next CP-OFDM symbol or set of CP-OFDM symbols.

In one instance of a transmission procedure described herein (e.g., with respect to any figure, description, or example herein, such as FIG. 11, 12, 13), the phase noise report may comprise an indication from the second WTRU or set of second WTRUs containing the preferred subcarrier partitioning, by means of an index to a codebook of a-priori defined combinations of lengths of the frequency-domain cyclic prefix and cyclic suffix, and subcarrier group sizes, that are known to the first WTRU or set of first WTRUs and the second WTRU or set of second WTRUs.

In one instance of a transmission procedure described herein (e.g., with respect to any figure, description, or example herein, such as FIG. 11, 12, 13), the high phase noise indication may be reported by the second WTRU in an uplink control or shared data channel, (e.g., PUCCH or PUSCH), or by means of a MAC CE.

In one instance of a transmission procedure described herein (e.g., with respect to any figure, description, or example herein, such as FIG. 11, 12, 13), the high phase noise indication may be reported by the second WTRU based on a phase noise threshold sent by the first WTRU or set of first WTRUs in a phase noise configuration message, such as in a downlink control or shared data channel, PDCCH or PDSCH, or by means of a MAC CE.

In one instance of a transmission procedure described herein (e.g., with respect to any figure, description, or example herein, such as FIG. 11, 12, 13), the subcarrier group size M may be equal to, or lower than, the channel's coherence bandwidth.

In one instance of a transmission procedure described herein (e.g., with respect to any figure, description, or example herein, such as FIG. 11, 12, 13), the frequency-domain cyclic prefix comprises a replica of the complex values associated with the last L_{CP} subcarriers in each subcarrier group that are prepended to provide signal circularity in the frequency domain.

In one instance of a transmission procedure described herein (e.g., with respect to any figure, description, or example herein, such as FIG. 11, 12, 13), the frequency-domain cyclic suffix comprises a replica of the complex values associated with the first L_{CS} subcarriers in each subcarrier group, that are appended to provide signal circularity in the frequency domain.

In one instance of a transmission procedure described herein (e.g., with respect to any figure, description, or example herein, such as FIG. 11, 12, 13), the length of the frequency-domain cyclic prefix can be zero, and the length of the frequency-domain cyclic suffix can be equal to the two-sided phase noise spectral width expressed in number of subcarriers.

In one instance of a transmission procedure described herein (e.g., with respect to any figure, description, or example herein, such as FIG. 11, 12, 13), the length of the frequency-domain cyclic suffix can be zero, and the length of the frequency-domain cyclic prefix can be equal to the two-sided phase noise spectral width expressed in number of subcarriers.

In one instance of a transmission procedure described herein (e.g., with respect to any figure, description, or example herein, such as FIG. 11, 12, 13), the length of the frequency-domain cyclic prefix and the frequency-domain cyclic suffix can be both equal to the one-sided phase noise spectral width expressed in number of subcarriers.

In one instance of a transmission procedure described herein (e.g., with respect to any figure, description, or example herein, such as FIG. 11, 12, 13), the rate matching function is to adjust the amount of data to be mapped to physical resources available after considering the frequency-domain cyclic prefix and/or cyclic suffix fields.

In one instance of a transmission procedure described herein (e.g., with respect to any figure, description, or example herein, such as FIG. 11, 12, 13), the first WTRU or set of first WTRUs transmitting control signaling information including any of an indication of the adaptation of phase noise mitigation parameters, updated value of a subcarrier group size (M), updated value of the length of a frequency-domain cyclic prefix (L_{CP}), and updated value of the length of a frequency-domain cyclic suffix (L_{CS}).

In one instance of a transmission procedure described herein (e.g., with respect to any figure, description, or example herein, such as FIG. 11, 12, 13), the first WTRU is a base station equipment and the second WTRU is a UE in the downlink of a wireless communication system.

In one instance of a transmission procedure described herein (e.g., with respect to any figure, description, or example herein, such as FIG. 11, 12, 13), the set of first WTRUs are multiple transmit-receive points in the downlink of a multi-TRP wireless communication system.

In one instance of a transmission procedure described herein (e.g., with respect to any figure, description, or example herein, such as FIG. 11, 12, 13), the first WTRU and the second WTRU are UE in the sidelink of a wireless communication system.

In one instance of a transmission procedure described herein (e.g., with respect to any figure, description, or example herein, such as FIG. 11, 12, 13), the first WTRU is a UE and the second WTRU is a base station equipment in the uplink of a wireless communication system.

In one instance of a transmission procedure described herein (e.g., with respect to any figure, description, or example herein, such as FIG. 11, 12, 13), the set of second WTRUs are multiple transmit-receive points in the uplink of a multi-TRP wireless communication system.

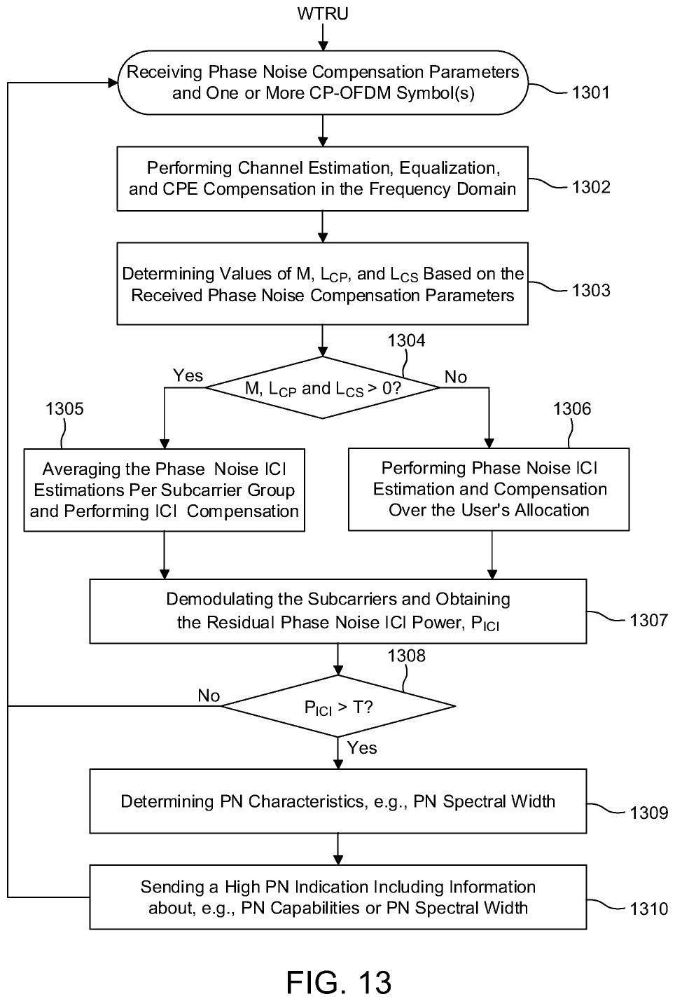

FIG. 13 illustrates an example procedure of reception of CP-OFDM signals based on phase noise cyclic partitioning. In this example, a first WTRU or set of first WTRUs receiving CP-OFDM symbols from a second WTRU or set of second WTRUs, may perform one or more of the following: at 1301, receiving a CP-OFDM symbol; at 1302, performing channel estimation, equalization, and/or common phase error compensation in the frequency domain of the received CP-OFDM; at 1303, obtaining/determining a subcarrier group size, M, and the lengths of the frequency-domain cyclic prefix, L_{CP}, and/or frequency-domain cyclic suffix, L_{CS}, via, (e.g., signaling indications); at 1304, determining that the parameters (e.g., M, L_{CP} and/or L_{CS}) are greater than zero, and if they are, at 1305, averaging the phase noise ICI components estimated in each subcarrier group, and performing phase noise ICI compensation; at 1304, if the parameters are not greater than zero, then at 1306, performing phase noise ICI estimation and compensation over the user's allocation; at 1307, demodulating the subcarriers and comparing the residual phase noise ICI power against a threshold; at 1308, if the residual phase noise ICI power is below a threshold, the process may return to the beginning 1301; at 1308, if the phase noise ICI power is above a threshold 1309, then determining the phase noise characteristics (e.g., a phase noise spectral width), based on said residual phase noise ICI power above a threshold (e.g., 1308); and/or, at 1310, sending a high phase noise indication containing information about the amount of phase noise expected or experienced in the communications link, such as phase noise capabilities information and/or phase noise spectral width; with 1310 complete, the process may return to any one of the preceding steps, such as 1301.

In one instance of a transmission procedure described herein (e.g., with respect to any figure, description, or example herein, such as FIG. 11, 12, 13), channel estimation may be performed by the first WTRU or set of first WTRUs by means of a demodulation reference signal (e.g., DM-RS), inserted in the frequency domain within the WTRU's allocated bandwidth.

In one instance of a transmission procedure described herein (e.g., with respect to any figure, description, or example herein, such as FIG. 11, 12, 13), the common phase error compensation may be performed by the first WTRU or set of first WTRUs by means of a phase tracking reference signal (e.g., PT-RS) inserted in the frequency domain within the WTRU's allocated bandwidth.

In one instance of a transmission procedure described herein (e.g., with respect to any figure, description, or example herein, such as FIG. 11, 12, 13), the subcarrier group size and the lengths of the frequency-domain cyclic prefix and/or cyclic suffix may be obtained by the first WTRU or set of first WTRUs by means of higher-layer signaling, e.g., via RRC phase noise configuration information.

In one instance of a transmission procedure described herein (e.g., with respect to any figure, description, or example herein, such as FIG. 11, 12, 13), the subcarrier group size and the lengths of the frequency-domain cyclic prefix and/or cyclic suffix may be obtained from a signaling indication sent by the second WTRU or set of second WTRUs, e.g., via a downlink shared control or data channel, PDCCH or PDSCH, or through a MAC CE.

In one instance of a transmission procedure described herein (e.g., with respect to any figure, description, or example herein, such as FIG. 11, 12, 13), the signaling indication may be sent by the second WTRU or set of second WTRUs in a periodic, semi-periodic, on-demand, or event-based fashion, with a periodicity obtained via higher-layer signaling or received in a phase noise configuration message via, for example, a downlink shared control or data channel, PDCCH or PDSCH, or a MAC CE.

In one instance of a transmission procedure described herein (e.g., with respect to any figure, description, or example herein, such as FIG. 11, 12, 13), the subcarrier group size and the lengths of the frequency-domain cyclic prefix and/or cyclic suffix may be obtained by means of an index to a codebook of a-priori defined combinations of lengths of the frequency-domain cyclic prefix and cyclic suffix, and subcarrier group sizes, that must be known to the first WTRU or set of first WTRUs and the second WTRU or set of second WTRUs for unambiguous detection.

In one instance of a transmission procedure described herein (e.g., with respect to any figure, description, or example herein, such as FIG. 11, 12, 13), the subcarrier group size and the lengths of the frequency-domain cyclic prefix and/or cyclic suffix may be obtained by the first WTRU or set of first WTRUs through blind detection.

In one instance of a transmission procedure described herein (e.g., with respect to any figure, description, or example herein, such as FIG. 11, 12, 13), estimation of the phase noise ICI components may involve obtaining, by the first WTRU or set of first WTRUs, a set of ICI coefficients in each of the one or more subcarrier groups, and further averaging the phase noise ICI components over the subcarrier groups to benefit from frequency diversity.

In one instance of a transmission procedure described herein (e.g., with respect to any figure, description, or example herein, such as FIG. 11, 12, 13), performing phase noise ICI compensation may be based on applying the Hermitian conjugate of the phase noise ICI spectral response based on the phase noise ICI components averaged over the subcarrier groups.

In one instance of a transmission procedure described herein (e.g., with respect to any figure, description, or example herein, such as FIG. 11, 12, 13), the residual phase noise ICI power may be measured by the first WTRU or set of first WTRUs from the average constellation error of the subcarrier complex symbols after demodulation.

In one instance of a transmission procedure described herein (e.g., with respect to any figure, description, or example herein, such as FIG. 11, 12, 13), the phase noise spectral width may be measured by the first WTRU or set of first WTRUs on the received symbol, or set of symbols, and expressed in units of Hz or number of subcarriers for the current numerology.

In one instance of a transmission procedure described herein (e.g., with respect to any figure, description, or example herein, such as FIG. 11, 12, 13), the threshold represents a maximum tolerable phase noise ICI power above which the first WTRU or set of first WTRUs sends a High phase noise indication to the second WTRU or set of second WTRUs requesting a reduction in the phase noise.

In one instance of a transmission procedure described herein (e.g., with respect to any figure, description, or example herein, such as FIG. 11, 12, 13), the value of said threshold may be obtained by means of higher-layer signaling, for example, via RRC phase noise configuration information.

In one instance of a transmission procedure described herein (e.g., with respect to any figure, description, or example herein, such as FIG. 11, 12, 13), the value of said threshold may be sent by the second WTRU or set of second WTRUs in a phase noise configuration message, for example, in a downlink shared control or data channel, PDCCH or PDSCH, or by means of a MAC CE.

In one instance of a transmission procedure described herein (e.g., with respect to any figure, description, or example herein, such as FIG. 11, 12, 13), the high phase noise indication may be reported by the first WTRU in an uplink shared control or data channel (e.g., PUCCH or PUSCH), or by means of a MAC CE.

In one instance of a transmission procedure described herein (e.g., with respect to any figure, description, or example herein, such as FIG. 11, 12, 13), the phase noise information may comprise the phase noise capabilities information or the amount of phase noise experienced in the communications link.

In one instance of a transmission procedure described herein (e.g., with respect to any figure, description, or example herein, such as FIG. 11, 12, 13), the phase noise information may comprise an indication to the second WTRU or set of second WTRUs containing the preferred subcarrier partitioning, by means of an index to a codebook of a-priori defined combinations of lengths of the frequency-domain cyclic prefix and cyclic suffix, and subcarrier group sizes, that are known to the first WTRU or set of first WTRUs and the second WTRU or set of second WTRUs.

In one instance of a transmission procedure described herein (e.g., with respect to any figure, description, or example herein, such as FIG. 11, 12, 13), the phase noise capabilities may comprise an indication of a-priori known radio-frequency category or oscillator quality class among a set of a-priori categories or classes, or an indication of the expected amount of phase noise experienced at typical operating conditions, such as temperature, power or cell load.

In one instance of a transmission procedure described herein (e.g., with respect to any figure, description, or example herein, such as FIG. 11, 12, 13), the amount of phase noise in the phase noise capabilities may be expressed as the phase noise spectral width measured in units of Hz or number of subcarriers for a given numerology or set of numerologies.

In one instance of a transmission procedure described herein (e.g., with respect to any figure, description, or example herein, such as FIG. 11, 12, 13), the amount of phase noise may be expressed as the number of non-negligible ICI coefficients in the phase noise spectral response at the current operating conditions.

In one instance of a transmission procedure described herein (e.g., with respect to any figure, description, or example herein, such as FIG. 11, 12, 13), the amount of phase noise may be expressed as the power of the experienced phase noise impairment in Watts, milliwatts, dBW, dBm, or any other suitable unit.

In one instance of a transmission procedure described herein (e.g., with respect to any figure, description, or example herein, such as FIG. 11, 12, 13), the amount of phase noise may be expressed as an indication of the post-detection signal-to-noise ratio measured at the receiving entity after equalization and phase noise compensation.

In one instance of a transmission procedure described herein (e.g., with respect to any figure, description, or example herein, such as FIG. 11, 12, 13), the amount of phase noise may be expressed as the residual mean-squared error of the detection at the output of the phase noise compensation algorithm.

In one instance of a transmission procedure described herein (e.g., with respect to any figure, description, or example herein, such as FIG. 11, 12, 13), the amount of phase noise may be expressed as the error vector magnitude of the constellation as seen at the receiving entity after equalization.

In one instance of a transmission procedure described herein (e.g., with respect to any figure, description, or example herein, such as FIG. 11, 12, 13), the first WTRU is a UE and the second WTRU is a base station equipment in the downlink of a wireless communication system.

In one instance of a transmission procedure described herein (e.g., with respect to any figure, description, or example herein, such as FIG. 11, 12, 13), the set of second WTRUs are multiple transmit-receive points in the downlink of a multi-TRP wireless communication system.

In one instance of a transmission procedure described herein (e.g., with respect to any figure, description, or example herein, such as FIG. 11, 12, 13), the first WTRU and the second WTRU are UE in the sidelink of a wireless communication system.

In one instance of a transmission procedure described herein (e.g., with respect to any figure, description, or example herein, such as FIG. 11, 12, 13), the first WTRU is a base station equipment and the second WTRU is a UE in the uplink of a wireless communication system.

In one instance of a transmission procedure described herein (e.g., with respect to any figure, description, or example herein, such as FIG. 11, 12, 13), the set of first WTRUs are multiple transmit-receive points in the uplink of a multi-TRP wireless communication system.

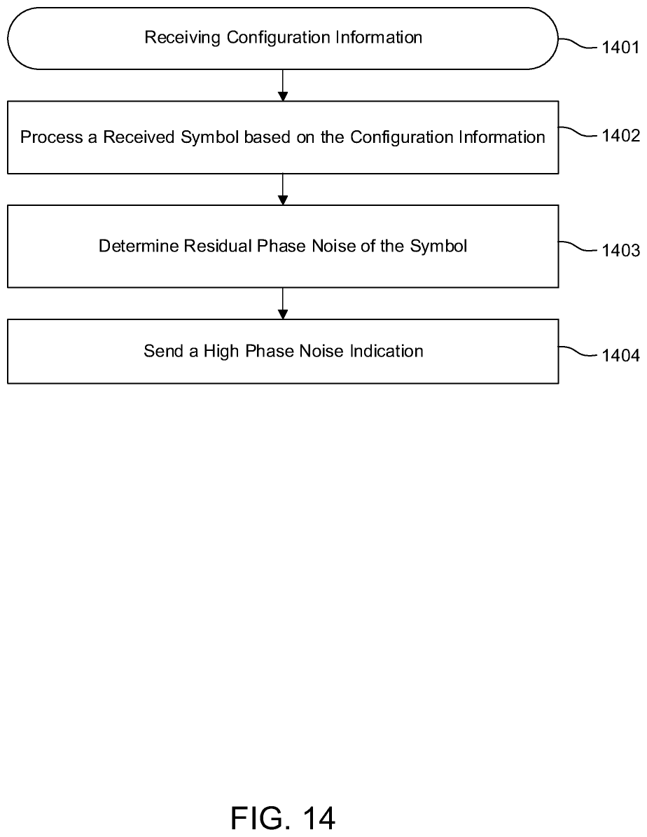

FIG. 14 illustrates an example method for determining and indicating high phase noise according to one or more techniques described herein. In this example, the method may be implemented by any device disclosed herein (e.g., network node, WTRU, TRP, base station, etc.). At 1401, the device may receive a configuration message, wherein the configuration message may include a subcarrier group size, a length of a frequency domain cyclic prefix (FD-CP), and/or a length of a frequency domain cyclic suffix (FD-CS). At 1402, the device may process a received symbol based on the configuration information. This processing may include performing phase noise inter carrier interference (ICI) compensation of a CP-OFDM symbol, based on a communications link for receiving the CP-OFDM symbol, using an averaged phase noise estimated from one or more subcarrier groups based on the subcarrier group size after removal of any one or more of a FP-CP or a FD-CS. The processing may also include demodulating subcarriers of the one or more subcarrier groups, and comparing a residual phase noise ICI power of the demodulated subcarriers against a threshold. At 1403, the device may determine phase noise characteristics based on the residual phase noise ICI power that is above the threshold. At 1404, the device may send a high phase noise indication that includes the phase noise characteristics, wherein the phase noise characteristics include information about an amount of expected phase noise or an amount of measured phase noise in the communications link for receiving the CP-OFDM symbol. In one instance that may be combined with other instances and examples, the configuration message is part of a control channel transmission, MAC CE, or RRC signaling. In one instance that may be combined with other instances and examples, the configuration message is determined through blind decoding. In one instance that may be combined with other instances and examples, the threshold is determined from RRC signaling. In one instance that may be combined with other instances and examples, the high phase noise indication is part of an uplink control channel message, uplink shared channel message, or a MAC CE. In one instance that may be combined with other instances and examples, the phase noise characteristics include a phase noise spectral width. In one instance that may be combined with other instances and examples, the device is a wireless transmit receive unit or a base station. As described herein, a transmitting entity and/or a receiving entity may generally refer to any device described herein, such as a WTRU and/or a base station.

As described herein, a higher layer may refer to one or more layers in a protocol stack, or a specific sublayer within the protocol stack. The protocol stack may comprise of one or more layers in a WTRU or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: Non Access Stratum (NAS), Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

Although features and elements are described above in particular combinations (e.g., embodiments, methods, examples, etc.), one of ordinary skill in the art will appreciate that each feature or element can be used alone or in any combination with the other features and elements. For example, as disclosed herein there may be a method described in association with a figure for illustrative purposes, and one of ordinary skill in the art will appreciate that one or more features or elements from this method may be used alone or in combination with one or more features from another method described elsewhere. In addition, any method described herein may be implemented in a device running a computer program, software, and/or firmware incorporated in a computer-readable medium for execution by a computer and/or processor operatively connected with a transceiver (e.g., wireless or wired) of the device. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method implemented by a device, the method comprising:
receiving a configuration message, wherein the configuration message includes a subcarrier group size, a length of a frequency domain cyclic prefix (FD-CP), or a length of a frequency domain cyclic suffix (FD-CS);
performing phase noise inter carrier interference (ICI) compensation of a CP-OFDM symbol based on the configuration message, wherein the configuration message is part of a control channel transmission, MAC CE, or RRC signaling;
demodulating subcarriers of one or more subcarrier groups, and comparing a residual phase noise ICI power of the demodulated subcarriers against a threshold;
determining phase noise characteristics based on the residual phase noise ICI power that is above the threshold; and
sending a high phase noise indication that includes the phase noise characteristics, wherein the high phase noise indication is part of an uplink control channel message, uplink shared channel message, or a MAC CE.

2. The method of claim 1, wherein the performing phase noise ICI compensation of the CP-OFDM symbol is further based on a communications link for receiving the CP-OFDM symbol, and is performed using an averaged phase noise estimated from the one or more subcarrier groups, where the averaged phase noise is based on the subcarrier group size after removal of any one or more of a FP-CP or a FD-CS.

3. The method of claim 1, wherein the configuration message is determined through blind decoding.

4. The method of claim 1, wherein the threshold is determined from RRC signaling.

5. The method of claim 1, wherein the phase noise characteristics include information about an amount of expected phase noise or an amount of measured phase noise in the communications link for receiving the CP-OFDM symbol.

6. The method of claim 1, wherein the phase noise characteristics include a phase noise spectral width.

7. The method of claim 1, wherein the device is a wireless transmit receive unit or a base station.

8. A device, the device comprising:
a processor operatively connected to a transceiver,
the processor and transceiver configured to receive a configuration message, wherein the configuration message includes a subcarrier group size, a length of a frequency domain cyclic prefix (FD-CP), or a length of a frequency domain cyclic suffix (FD-CS);
the processor configured to perform phase noise inter carrier interference (ICI) compensation of a CP-OFDM symbol based on the configuration message, wherein the configuration message is part of a control channel transmission, MAC CE, or RRC signaling;
the processor configured to demodulate subcarriers of one or more subcarrier groups, and comparing a residual phase noise ICI power of the demodulated subcarriers against a threshold;
the processor configured to determine phase noise characteristics based on the residual phase noise ICI power that is above the threshold; and
the processor and transceiver configured to send a high phase noise indication that includes the phase noise characteristics, wherein the high phase noise indication is part of an uplink control channel message, uplink shared channel message, or a MAC CE.

9. The device of claim 8, wherein the performing phase noise ICI compensation of the CP-OFDM symbol is further based on a communications link for receiving the CP-OFDM symbol, and is performed using an averaged phase noise estimated from the one or more subcarrier groups, where the averaged phase noise is based on the subcarrier group size after removal of any one or more of a FP-CP or a FD-CS.

10. The device of claim 8, wherein the configuration message is determined through blind decoding.

11. The device of claim 8, wherein the threshold is determined from RRC signaling.

12. The device of claim 8, wherein the phase noise characteristics include information about an amount of expected phase noise or an amount of measured phase noise in the communications link for receiving the CP-OFDM symbol.

13. The device of claim 8, wherein the phase noise characteristics include a phase noise spectral width.

14. The device of claim 8, wherein the device is a wireless transmit receive unit or a base station.
